(19) United States
(12) Patent Application Publication
(10) Pub. No.: US 2025/0356390 A1
(43) Pub. Date: Nov. 20, 2025

(54) SYSTEM AND METHOD OF INITIATING PAYMENT TRANSACTIONS

(71) Applicant: Olga VENCHEVA, Mississauga (CA)

(72) Inventor: Olga VENCHEVA, Mississauga (CA)

(21) Appl. No.: 19/206,091

(22) Filed: May 13, 2025

Related U.S. Application Data
(60) Provisional application No. 63/648,187, filed on May 16, 2024.

(51) Int. Cl. G06Q 30/0226; G06Q 20/20; G06Q 20/32; G06Q 20/36; G06Q 20/40

(52) U.S. Cl. CPC G06Q 30/0226; G06Q 20/20; G06Q 20/322; G06Q 20/327; G06Q 20/363; G06Q 20/40145

(57) ABSTRACT

The present invention relates generally to the technological field of systems and methods specially adapted for commercial purposes, in particular, to payment architectures, schemes and protocols. A system and method of initiating payment transactions are suggested, which provide an improvement of the technological field by: (a) reducing computational loads on the mobile devices and POS-terminals and decreasing a number of actions performed at the consumer's end to initiate the electronic payment transaction, thereby accelerating a completion thereof; (b) decreasing a complexity of integration with existing technological solutions; and (c) maintaining the required security level.

### CROSS-REFERENCE TO RELATED APPLICATIONS

This application claims priority to U.S. Provisional Application No. 63/648,187, titled “SYSTEM AND METHOD OF INITIATING PAYMENT TRANSACTIONS”, filed May 16, 2024, which is hereby incorporated by reference in its entirety.

### FIELD OF THE INVENTION

The present invention relates generally to the technological field of systems and methods specially adapted for commercial purposes, in particular, to payment architectures, schemes and protocols. More specifically, the present invention relates to technical solutions for efficiently operating with digital wallet information, in particular, automating a determination of the most cost-effective payment method purchase-wise.

### BACKGROUND OF THE INVENTION

Nowadays, the rapid development of information technologies has led to the ubiquitous usage of mobile payments. Currently deployed technical solutions helped to increase both security of confidential information (e.g., payment credentials, authentication data etc.) as well as simplicity and convenience of use.

One of the main concepts related to mobile payments lies in providing a digital representation of wallet content. A digital wallet streamlines the payment process by storing information associated with transactions. It facilitates fast, convenient, and secure commerce using mobile devices.

Currently, digital wallets may store a wide variety of information: credit card and debit card information, identity documents, health fund cards, loyalty cards, gift cards, event tickets and boarding passes, e-keys etc.

Known technical solutions for digital wallets, e.g., Apple Pay, Google Pay, Samsung Pay etc., utilize the following common architecture. A digital wallet of a customer is stored locally on the mobile device thereof. A digital payment card (debit or credit card), when being uploaded to the digital wallet, undergoes the process of “tokenization”-a security technique that replaces sensitive payment information, such as credit card numbers, with a unique, random set of characters called a “token”. This security technique is usually provided by a third-party tokenization vendor and is performed on a designated secure tokenization server. Once obtained, the token is stored in the digital wallet on the mobile device and, during the payment transaction, is transferred back to the tokenization server, where it undergoes “detokenization”—a reverse procedure to get back the payment information and to proceed with funds transferring. This process helps keeping payment data safe during transactions because the actual card information is not being used or stored. If someone were to access the token, they would not be able to use it to make fraudulent purchases since it does not contain the real payment details. By using tokens instead of actual card information, businesses can provide a secure and seamless payment experience for their customers while reducing the risk of data breaches and fraud.

It should be noted that, in current systems, the token and payment card number must be realized within a single payment architecture (e.g., Visa, MasterCard etc.), hence, must be technologically identical (e.g., have exactly 16 digits etc.).

As for loyalty cards, they represent a popular marketing tool used by businesses to encourage repeat customer behavior and build brand loyalty. Loyalty cards may currently be digitalized and integrated into business mobile apps and digital wallets. The main advantage of using digital loyalty cards is that they are always accessible and cannot be lost.

The primary goal of digitizing wallets, and, in particular, loyalty cards, is to enhance the customer's checkout experience and improve payment transaction efficiency, in particular, by accelerating the payment transaction while maintaining robust security. However, this goal has not yet been fully achieved by currently known solutions.

Nowadays, to use a loyalty card, a customer is required to select it from the content of the digital wallet, using a user interface (UI) of his mobile device, and then to show it to the merchant representative (same, as if it was a non-digital loyalty card). The merchant representative may then scan a QR-code or barcode, shown on the screen of the customer's mobile device, to identify the loyalty card by merchant's payment system. Then, the total amount to be paid is recalculated, based on the identified loyalty card, and, after that, the customer may choose a desired payment card from the digital wallet content to be used for the payment, e.g., via NFC protocol.

Recently, more progressive solutions have emerged. E.g., Apple Pay service provides a technology that enables transferring loyalty card information to POS-terminal via NFC protocol, same as in case of payment cards. However, Apple Pay solution has certain drawbacks. It relies on a proprietary communication protocol called Apple Value Added Services (Apple VAS), which both the mobile device and POS-terminal must support. Furthermore, the entire payment procedure is accompanied with redundant actions and computations to be performed at the user's side: user is required to select a desired loyalty card from the content of the digital wallet, and to bring his mobile device close to the NFC module of the POS terminal to transfer the loyalty card information; then, the user is required to select a desired payment card and to bring his mobile device close to the NFC module of the POS-terminal once again, to transfer the payment card information. Certainly, transferring the payment card information and loyalty card information separately (via different protocols and different communication sessions) complicates the procedure and increases computational loads, not to mention negative effect on the user experience. Furthermore, the known issue with near-field communications is that the connection tends to break due to inconsistency in the distance between the mobile device and the POS-terminal. E.g., the user may slightly move his mobile device away from the POS-terminal while the data is being transmitted, thereby causing the connection to break. In such cases, the user is then requested to repeat the same actions to re-initiate the data transmission. In the case of Apple Pay solution for loyalty cards, two consecutive data transmissions must be conducted, which multiplies the probability of having at least one connection break during such a procedure. Accordingly, the entire payment transaction comes out slow, inefficient, and computationally heavy.

When discussing innovations in the technological field of payment architectures, schemes and protocols, another aspect should be taken into consideration. It should be noted that, when introducing any new solutions, ensuring data security, compliance, and seamless integration with existing systems become critical challenges. Most prima-facie perspective solutions may never get to the practical implementation due to issues with integration. E.g., to integrate Apple Pay solution for loyalty cards, POS-terminal must be updated (either or both in regard of hardware and software), to support Apple VAS protocol, thereby significantly hampering the solution integration.

### SUMMARY OF THE INVENTION

Accordingly, there is a need for a system and method of initiating payment transactions, which would provide an improvement of the technological field of systems and methods specially adapted for commercial purposes (in particular, the field of payment architectures, schemes and protocols), by: (a) reducing computational loads on the mobile devices and POS-terminals and decreasing a number of actions performed at the consumer's end to initiate the electronic payment transaction, thereby accelerating a completion thereof; (b) decreasing a complexity of integration with existing technological solutions; and (c) maintaining the required security level.

The present invention aims to address the previously mentioned issues of the prior art and achieve the declared objectives.

In the general aspect, the invention may be directed to a method of initiating payment transactions, by at least one processor. The method may include: establishing wireless connection between a payment terminal and a mobile device, said payment terminal being connected to a payment server; receiving, by the payment terminal from the mobile device via the established wireless connection, a payment token; receiving, by the payment server from the payment terminal: (i) the payment token, (ii) a store or product identifier, and (iii) an amount to be paid; retrieving, from a database stored on the payment server, a digital wallet information comprising: one or more bank account data elements, and a loyalty card data element; said digital wallet information being associated with the received payment token, and said loyalty card data element being further associated with the received store or product identifier; recalculating, by the payment server, the amount to be paid, based on the retrieved loyalty card data element; and initiating, by the payment server, the payment transaction, using: (i) the recalculated amount to be paid; and (ii) the retrieved one or more bank account data elements.

In another general aspect, the invention may be directed to a system for initiating payment transactions. The system may include: a mobile device; a payment terminal; and a payment server in operative connection with the payment terminal; wherein each of the mobile device, the payment terminal and the payment server may include a non-transitory memory module, wherein modules of program instructions may be stored, and at least one processor associated with the memory module, and configured to execute the modules of program instructions, whereupon execution of said modules of program instructions, the processors of the mobile device and the payment terminal may be configured to establish wireless connection between the payment terminal and the mobile device; the processor of the mobile device may be configured to transfer, to the payment terminal, via the established wireless connection, a payment token; the processor of the payment terminal may be configured to: receive, from the mobile device, via the established wireless connection, the payment token; and transfer, to the payment server: (i) the payment token, (ii) a store or product identifier, and (iii) an amount to be paid; and the processor of the payment server may be configured to: receive, from the payment terminal: (i) the payment token, (ii) a store or product identifier, and (iii) an amount to be paid; retrieve, from a database stored on the payment server, a digital wallet information comprising: one or more bank account data elements, and a loyalty card data element; said digital wallet information being associated with the received payment token, and said loyalty card data element being further associated with the received store or product identifier; recalculate the amount to be paid based on the retrieved loyalty card data element; and initiate the payment transaction, using: (i) the recalculated amount to be paid; and (ii) the retrieved one or more bank account data elements.

In certain embodiments, the payment token may be a numerical or alphanumerical identification code.

In certain embodiments, the one or more bank account data elements may include a bank account identifier, said bank account identifier selected from a list consisting of: (i) a credit card number associated with an authorized user of the mobile device; (ii) a billing address associated with the authorized user of the mobile device; and (iii) a bank account number associated with the authorized user of the mobile device.

In certain embodiments, the digital wallet information may further include a plurality of loyalty card data elements, containing the loyalty card data element associated with the received store or product identifier, said plurality of loyalty card data elements being associated with the payment token. The method may further include selecting the loyalty card data element associated with the received store or product identifier from the plurality of loyalty card data elements, based on the received store and product identifier.

In certain embodiments, the method may further include: providing, via a user interface (UI) of the payment terminal, a first suggestion data element representing a suggestion of obtaining at least one of: new loyalty card data elements; new credit card data elements; and new bank accounts; based on at least one of: the retrieved digital wallet information; the amount to be paid; and the store or product identifier.

In certain embodiments, the method may further include: inferring, by the payment server, a respectively pretrained first machine-learning (ML)-based model on: the retrieved digital wallet information; the amount to be paid; and the store or product identifier, to calculate one or more cost-effective payment methods, each comprising at least one of: (i) a combined application of a specific bank account identifier of the one or more bank account identifiers and a specific loyalty card data element of the plurality of loyalty card data elements; (ii) a combined application of a specific bank account identifier of the one or more bank account identifiers and a specific new loyalty card data element; (iii) a combined application of a specific new bank account or a specific new credit card data element and a specific loyalty card data element of the plurality of loyalty card data elements; (iv) a combined application of a specific new bank account or a specific new credit card data element and a specific new loyalty card data element; (v) credit, and/or loan, and/or split payments options; and (vi) payment options involving cryptocurrencies and/or central bank digital currencies (CBDC). Said initiating of the payment transaction may further be based on the calculated one or more cost-effective payment methods.

In certain embodiments, the method may further include: for each of the one or more cost-effective payment methods, calculating confidence metric value, representing a probability of a respective cost-effective payment method of the one or more cost-effective payment methods to have the highest cost effectiveness. Said initiating the payment transaction may further be performed based on a first cost-effective payment method of the one or more cost-effective payment methods, said first cost-effective payment method having a highest calculated confidence metric value.

In certain embodiments, the method may further include: providing, via a user interface (UI) of the payment terminal, a second suggestion data element representing a suggestion of selecting one of the one or more cost-effective payment methods; receiving, via the UI of the payment terminal, a current user response data element representing one of (a) a confirmation of selecting the one of the one or more cost-effective payment methods; and (b) a declination of selecting the one of the one or more cost-effective payment methods; receiving, by the payment server from the payment terminal, the current user response data element. Said initiating of the payment transaction may be further preformed, based on the current user response data element.

In certain embodiments, the method may further include: inferring, by the payment server, a respectively pretrained second ML-based model on the calculated one or more cost-effective payment methods, to calculate, for each of the one or more cost-effective payment methods, a probability of receiving a user response data element respectively representing one of (a) a confirmation of selecting a respective cost-effective payment method of the one or more cost-effective payment methods; and (b) a declination of selecting the respective cost-effective payment method of the one or more cost-effective payment methods; and providing, via the UI of the payment terminal, the second suggestion data element further based on the calculated probability.

In certain embodiments, the method may further include: receiving, by the payment server, a plurality of retrospective user response data elements, each representing one of (a) a confirmation of selecting the respective cost-effective payment method of the one or more cost-effective payment methods; and (b) a declination of selecting the respective cost-effective payment method of the one or more cost-effective payment methods, said retrospective user response data elements being received during previous payment transactions; and training, by the payment server, the second ML-based model to calculate a probability of receiving upcoming user response data elements, each representing one of (a) a confirmation of selecting the respective cost-effective payment method of the one or more cost-effective payment methods; and (b) a declination of selecting the respective cost-effective payment method of the one or more cost-effective payment methods, by using the plurality of retrospective user response data elements as a supervisory dataset.

In certain embodiments, the method may further include: supplementing, by the payment server, the supervisory dataset with the current user response data element; and retraining, by the payment server, the second ML-based model using the supplemented supervisory dataset.

In certain embodiments, the one or more bank account data elements may further include at least one fee value associated with said bank account identifier; and the method may further include: for each of the one or more bank account data elements: (i) calculating a frequency of performing payment transactions using a respective bank account identifier; and (ii) recalculating a respective at least one fee value, based on the calculated frequency. Said inferring, by the payment server, the respectively pretrained first ML-based model may be further performed on the recalculated at least one fee value, to calculate the one or more cost-effective payment methods.

In certain embodiments, the method may further include: providing, via a user interface (UI) of the payment terminal, a third suggestion data element representing a suggestion of purchasing a new product, based on at least one of: the store or product identifier; and a plurality of store or product identifiers associated with previous transactions.

In certain embodiments, the method may further include: receiving, by the payment terminal from the mobile device via the established wireless connection, a reference authentication data element, uniquely identifying the authorized user of the mobile device; receiving, via an input module of the payment terminal, an input authentication data element, entered by a current user, said input authentication data element uniquely identifying the current user; receiving, by the payment server from the payment terminal: (i) the reference authentication data element; and (ii) the input authentication data element; determining, by the payment server, a similarity metric value, representing a degree of similarity between the reference authentication data element and the input authentication data element. Said initiating the payment transaction may further include authorizing the payment transaction, based on the similarity metric value.

In certain embodiments, the input module may include a biometric data capturing module, and the reference authentication data element and the input authentication data element may represent biometric data of the authorized user and the current user, respectively.

In certain embodiments, authorizing the payment transaction, based on the similarity metric value, may include confirming that the current user is the authorized user, provided that the similarity metric value surpasses a predefined similarity metric threshold value.

In certain embodiments, the method may further include: receiving, by a merchant bank server associated with the store or product identifier, from the payment server, a fund transfer mandate data element, providing permission to request, from one or more user bank servers associated with a respective retrieved one or more bank account identifiers, a fund transfer to a merchant bank account according to the recalculated amount to be paid; and initiating, by the merchant bank server, the fund transfer to the merchant bank account according to the fund transfer mandate data element.

In certain embodiments, the method may further include: retrieving, from the database stored on the payment server, the fund transfer mandate data element, based on at least one of: (i) the payment token; and (ii) the reference authentication data element; amending the fund transfer mandate data element to provide permission to the merchant bank server associated with the store or product identifier to request, from one or more user bank servers associated with the respective retrieved one or more bank account identifiers, a fund transfer to the merchant bank account according to the recalculated amount to be paid; and transferring, from the payment server to the merchant bank server, the fund transfer mandate data element, provided that the payment transaction is authorized.

In certain embodiments, the method may further include: receiving, by one or more user bank servers associated with a respective retrieved one or more bank account identifiers, from the payment server, a fund transfer mandate data element, providing permission to transfer, to a merchant bank account associated with the store or product identifier, funds according to the recalculated amount to be paid; initiating, by the one or more user bank servers, the fund transfer to the merchant bank account according to the fund transfer mandate data element.

In certain embodiments, the method may further include: retrieving, from the database stored on the payment server, the fund transfer mandate data element, based on at least one of: (i) the payment token; and (ii) the reference authentication data element; amending the fund transfer mandate data element to provide permission to the one or more user bank servers associated with the respective retrieved one or more bank account identifiers to transfer, to the merchant bank account associated with the store or product identifier, funds according to the recalculated amount to be paid; and transferring, from the payment server to the one or more user bank servers, the fund transfer mandate data element, provided that the payment transaction is authorized.

In certain embodiments, the method may further include: receiving, by the mobile device from the payment server, a fund transfer template data element; signing, by the mobile device, the fund transfer template data element using a digital signature of the authorized user, thereby generating the fund transfer mandate data element; and transferring, from the mobile device to the payment server, the fund transfer mandate data element.

In certain embodiments, the method may further include: receiving, by the payment server from the mobile device, a request to generate the payment token; generating, by the payment server, the payment token, based on the received request to generate the payment token; transferring, from the payment server to the mobile device, the payment token.

In some embodiments, the invention may be directed to a method of initiating online payment transactions, by at least one processor. The method may include: receiving, by a merchant server running an online purchase service, an online payment action indicating a request from a current user to initiate a payment transaction; transmitting, by the merchant server, upon receiving the request from the current user, (i) a payment token, (ii) a store or product identifier, and (iii) an amount to be paid to a payment server; retrieving, from a database stored on the payment server, a digital wallet information comprising: one or more bank account data elements, and a loyalty card data element; said digital wallet information being associated with the received payment token, and said loyalty card data element being further associated with the received store or product identifier; recalculating, by the payment server, the amount to be paid, based on the retrieved loyalty card data element; and initiating, by the payment server, the payment transaction, using: (i) the recalculated amount to be paid; and (ii) the retrieved one or more bank account data elements.

In another general aspect, the invention may be directed to a system for initiating online payment transactions. The system may include: a merchant server; and a payment server; wherein each of the merchant server and the payment server may include a non-transitory memory module, wherein modules of program instructions may be stored, and at least one processor associated with the memory module, and configured to execute the modules of program instructions, whereupon execution of said modules of program instructions, the processor of the merchant server may be configured to: receive an online payment action indicating a request from a current user to initiate a payment transaction; and transmitting, upon receiving the request from the current user, (i) a payment token, (ii) a store or product identifier, and (iii) an amount to be paid to a payment server; and the processor of the payment server may be configured to: receive, from the payment terminal: (i) the payment token, (ii) a store or product identifier, and (iii) an amount to be paid; retrieve, from a database stored on the payment server, a digital wallet information comprising: one or more bank account data elements, and a loyalty card data element; said digital wallet information being associated with the received payment token, and said loyalty card data element being further associated with the received store or product identifier; recalculate the amount to be paid based on the retrieved loyalty card data element; and initiate the payment transaction, using: (i) the recalculated amount to be paid; and (ii) the retrieved one or more bank account data elements.

In certain embodiments, the method may further include: providing, via a user interface (UI) of a mobile device, a first suggestion data element representing a suggestion of obtaining at least one of: new loyalty card data elements; new credit card data elements; and new bank accounts; based on at least one of: the retrieved digital wallet information; the amount to be paid; and the store or product identifier. Accordingly, in some embodiments, the system may further include the mobile device. The mobile device may include a non-transitory memory module, wherein modules of program instructions may be stored, and at least one processor associated with the memory module, and configured to execute the modules of program instructions, whereupon execution of said modules of program instructions, the processor of the mobile device may be configured to: provide, via a user interface (UI) of a mobile device, a first suggestion data element representing a suggestion of obtaining at least one of: new loyalty card data elements; new credit card data elements; and new bank accounts; based on at least one of: the retrieved digital wallet information; the amount to be paid; and the store or product identifier.

In certain embodiments, the method may further include: providing, via a user interface (UI) of the mobile device, a second suggestion data element representing a suggestion of selecting one of the one or more cost-effective payment methods; receiving, via the UI of the payment terminal, a current user response data element representing one of (a) a confirmation of selecting the one of the one or more cost-effective payment methods; and (b) a declination of selecting the one of the one or more cost-effective payment methods; receiving, by the payment server from the payment terminal, the current user response data element. Said initiating of the payment transaction may be further preformed, based on the current user response data element.

In certain embodiments, the method may further include: inferring, by the payment server, a respectively pretrained second ML-based model on the calculated one or more cost-effective payment methods, to calculate, for each of the one or more cost-effective payment methods, a probability of receiving a user response data element respectively representing one of (a) a confirmation of selecting a respective cost-effective payment method of the one or more cost-effective payment methods; and (b) a declination of selecting the respective cost-effective payment method of the one or more cost-effective payment methods; and providing, via the UI of the mobile device, the second suggestion data element further based on the calculated probability.

In certain embodiments, the method may further include: providing, via a user interface (UI) of the mobile device, a third suggestion data element representing a suggestion of purchasing a new product, based on at least one of: the store or product identifier; and a plurality of store or product identifiers associated with previous transactions.

In certain embodiments, the method may further include: receiving, via an input module of the mobile device, an input authentication data element, entered by a current user, said input authentication data element uniquely identifying the current user; receiving, by the payment server from the mobile device: (i) a reference authentication data element, uniquely identifying the authorized user of the mobile device; and (ii) the input authentication data element; determining, by the payment server, a similarity metric value, representing a degree of similarity between the reference authentication data element and the input authentication data element. Said initiating the payment transaction may further include authorizing the payment transaction, based on the similarity metric value.

In certain embodiments, the input module may include a biometric data capturing module, and the reference authentication data element and the input authentication data element may represent biometric data of the authorized user and the current user, respectively.

### BRIEF DESCRIPTION OF THE DRAWINGS

The invention is particularly defined and distinctly claimed in the final section of the specification. However, to better comprehend the organization, method of operation, as well as the associated essential features and improvements provided thereby, one should refer to the detailed description provided below, along with the following accompanying drawings:

FIG. 1A is a flow diagram, depicting a method of initiating payment transactions, according to certain embodiments;

FIG. 1B is a flow diagram, depicting a method of initiating online payment transactions, according to certain embodiments;

FIG. 2 is a block diagram, depicting a computing device which may be included in a system for initiating payment transactions, according to certain embodiments;

FIG. 3A is a block diagram, depicting aspects of a mobile device and a payment terminal of a system for initiating payment transactions (for POS purchases), according to certain embodiments;

FIG. 3B is a block diagram, depicting aspects of a payment server of the system for initiating payment transactions (for POS purchases), according to certain embodiments;

FIG. 3C is a block diagram, depicting aspects of a mobile device and a merchant server of a system for initiating payment transactions (for online purchases), according to certain embodiments;

FIG. 3D is a block diagram, depicting aspects of a payment server of the system for initiating payment transactions (for online purchases), according to certain embodiments;

FIG. 4A is a sequence diagram, depicting aspects of a cost-effective payment method determination, as performed by the system for initiating payment transactions, according to certain embodiments (for POS purchases); and

FIG. 4B is a sequence diagram, depicting aspects of payment token and fund transfer mandate data element generation and usage, as well as aspects of a payment transaction authorization, as performed by the system for initiating payment transactions, according to certain embodiments.

FIG. 4C is a sequence diagram, depicting aspects of a cost-effective payment method determination, as performed by the system for initiating payment transactions (for online purchases), according to certain embodiments; and

It shall be appreciated that, where considered appropriate, reference numerals may be repeated among the figures to indicate corresponding or analogous elements.

### DETAILED DESCRIPTION OF THE PRESENT INVENTION

A person skilled in the art will recognize that the present invention can take on various forms and embodiments without deviating from its fundamental concept or essential features. The embodiments provided herein should therefore be regarded as non-exclusive and illustrative rather than limiting with respect to the invention described herein. The scope of the invention shall be considered defined by the appended claims, rather than by the preceding description, and all changes that come within the meaning and range of equivalency of the claims are therefore intended to be embraced therein.

In the detailed description, specific details are presented to facilitate an understanding of the invention, although the present invention can be implemented without reliance on these specific details. For the sake of clarity, discussions pertaining to identical or analogous features or elements may not be repeated. Certain well-known methods, procedures, and components may not be explained herein to avoid obscuring the essence of the present invention. Additionally, features or elements described in relation to one embodiment may be combined with features or elements described in relation to other embodiments.

It shall be understood that, in the context of present disclosure, the terms “plurality” and “a plurality” may include, e.g., “multiple” or “two or more” and may be used to describe two or more elements. The term “set” as used herein may include one or more items.

It shall be understood that, in the present disclosure, the terms such as “user”, “cardholder”, and “consumer” refer to the same party of the payment transaction and, therefore, these terms may be used interchangeably.

It shall be understood that, in the present disclosure, the terms such as “payment terminal”, “point-of-sale terminal” and “POS-terminal” refer to the same device and, therefore, may be used interchangeably.

It shall be understood that, in the present disclosure, the terms such as “payment card”, “credit card” or “debit card” may refer to the same element and, therefore may be used interchangeably.

It shall be understood that, in the context of the present invention, discussions involving terms such as, for example, “transmitting”, “receiving”, “obtaining”, “retrieving”, “processing,” “computing,” “calculating,” “determining,” “establishing”, “analyzing”, “selecting”, “training” or the like, may refer to an operation of a processor or similar electronic computing device, that operates with and transforms data represented as physical (e.g., electronic) quantities within the computer's registers, memories, or other non-transitory storage mediums into other data similarly represented as physical quantities within the computer's registers, memories, or other information non-transitory storage mediums, to perform respective operations.

It shall be understood that, in the context of the present invention, the term “loyalty card” may refer to any digital data element, that (a) is associated with a specific product (or group of products) and/or a store (or group of stores); and (b) may be used to recalculate the amount to be paid (i.e., the price) for the specific product (or group of products). Thereby, in the broadest reasonable interpretation, the term “loyalty card” may also refer to a “bonus card”, a “gift card” etc. Accordingly, in the present disclosure, these terms may be used interchangeably.

It shall be understood that, in the context of the present invention, when referring to a “digital wallet”, elements such as “loyalty cards” or “payment cards” shall be understood as virtual substitutes for respective physical cards, and may be referred herein as, e.g., “loyalty card data element”, “credit card data element” etc.

The method embodiments described herein are not limited to any specific order or sequence unless stated otherwise. Certain method embodiments shall not be considered having any predetermined constraints as for comprising steps that may occur or be executed repeatedly, iteratively, simultaneously etc.

In embodiments of the present invention, some steps of the claimed method (e.g., calculating confidence metric value, representing a probability of a respective cost-effective payment method of the one or more cost-effective payment methods to have the highest cost effectiveness; calculating a probability of receiving a specific user response data element; and calculating a similarity metric value, when authorizing a payment transaction) may be performed using machine-learning (ML)-based models. ML-based models may be configured or “trained” for a specific task, e.g., classification or regression.

It would be apparent to one skilled in the art that various structures of machine learning (ML)-based models can be implemented without deviating from the core principles of the present invention. In certain embodiments, an ML-based model may consist of either a single ML-based model or an ensemble of ML-based models that collectively perform the same function as a single model. Therefore, considering the scope of the present invention, the aforementioned variations should be deemed equivalent.

In certain embodiments, ML-based models may be artificial neural networks (ANN).

Artificial Neural Networks (ANNs) are computational models inspired by the structure and functioning of the human brain. They are a subset of machine learning algorithms used for tasks such as classification, regression, and pattern recognition. ANNs consist of interconnected processing elements called neurons or nodes. These nodes are organized in layers and linked to work together for processing and learning from input data, thereby providing a powerful tool for solving complex problems. The links may transfer signals between nodes and may be associated with weights. The nodes and links within an ANN are represented by mathematical structures and elements, such as activation functions and matrices of data elements and weights. Training ANNs involves iteratively adjusting the weights of interconnected neurons to learn from input data including training examples. During the first training stage—forward propagation—input data passes through the network, and neurons compute weighted sums, apply activation functions, and pass results to subsequent layers. The calculated loss function quantifies prediction accuracy. At the next stage—backpropagation—gradients of the loss with respect to the weights are calculated, enabling weight updates. Training occurs in epochs, with data divided into smaller batches. After training, models are evaluated on validation and test datasets to assess generalization. ANNs capture intricate patterns, making them essential in modern machine learning applications. It shall be understood that the computations associated with training and inferring artificial neural networks (ANNs) are to be performed by a processor of a respective computing device.

According to the concept of the present invention, it is suggested to use a single payment token as an identifier of the entire customer's digital wallet, and not an identifier of a specific payment card or loyalty card. Such a payment token may be transferred from the customer's mobile device to the POS-terminal the same way as it is done currently (e.g., using NFC protocol) and, accordingly, may not require any complex upgrade of currently used POS-terminals.

A crucial aspect of the integration into currently used payment architectures is about the extent of the upgrade required for remote devices that are currently issued worldwide, e.g., POS-terminals, etc. With an increase of this extent, e.g., when it involves both hardware and software adjustments, the associated expenses escalate progressively and may cause the entire solution to be declined. The impact of upgrading the server components has a relatively minor effect on the entire integration expenses, thereby, such an upgrade does not significantly constrain the solutions to be integrated with the existing ones.

As the present invention, in the general aspect, may not require any complex upgrade of POS-terminals, it may be easily integrated with existing technological solutions.

Furthermore, according to the present invention, the digital wallet is stored on the server side (e.g., on the designated payment server), and not on the mobile devices, which enables multiple previously unreachable functionalities. For example, in the present solution, the server-side components (e.g., the payment server) can automatically determine which loyalty card of the plurality of loyalty cards stored in the customer's digital wallet would be accepted by the merchant with which the current purchase is being made, and automatically apply the target loyalty card to recalculate the amount to be paid.

Accordingly, the payment transaction may be conducted in a more seamless and efficient manner, since, unlike the solutions known in the art, no additional actions are required at the customer's side to select and apply the desired loyalty card. The computational loads at the customer's side may also be reduced accordingly: in the broadest reasonable implementation of the present invention, less interaction with the mobile device's user interface is required to perform the transaction (no additional searching and selecting the loyalty card is required); no need of using two separate near-field transmissions to send both payment card information and loyalty card information-everything is performed within a single transmission session, by sending a single token, etc. Furthermore, the latter provides for the reduced probability of having the near-field connection failure during the payment transaction, since less data is to be transmitted thereby, and also because a single transmission session suffices. Accordingly, the payment transaction may become less time-consuming.

In terms of security, the suggested approach may apply all currently enabled security measures: e.g., to get access to the payment token and to approve its transmission, the customer may be asked to authenticate himself, e.g., by using fingerprint or face recognition, using the respective modules of the mobile device. However, certain embodiments of the present invention (described further below) introduce additional security measures, which, in combination with aforementioned functions, represent an architecture of even greater security.

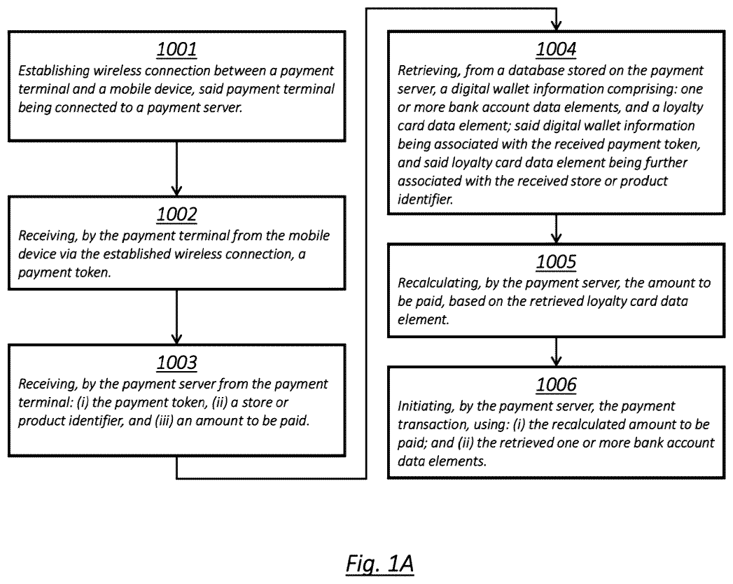

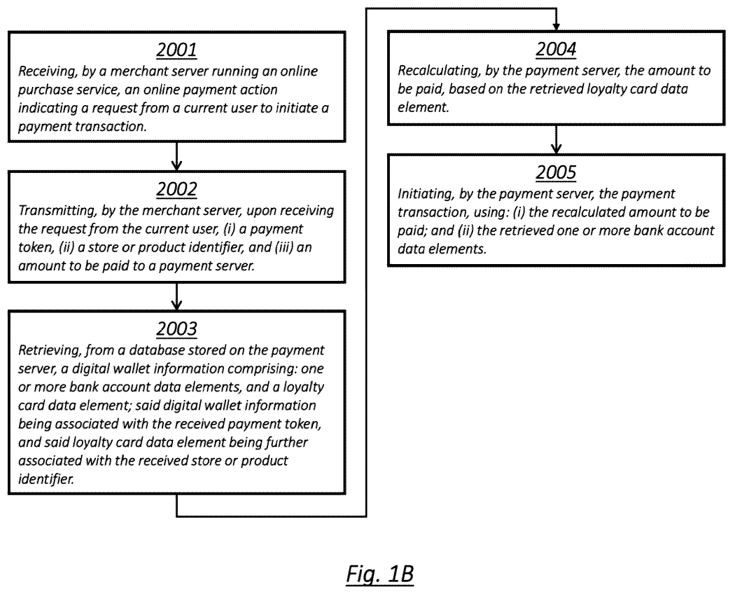

Referring now to FIG. 1A, a flow diagram is presented, illustrating a method of initiating payment transactions, according to certain embodiments of the present invention.

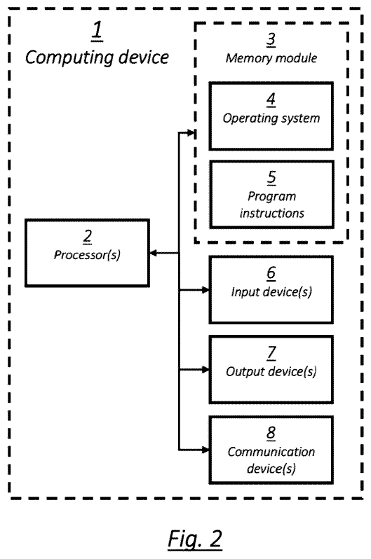

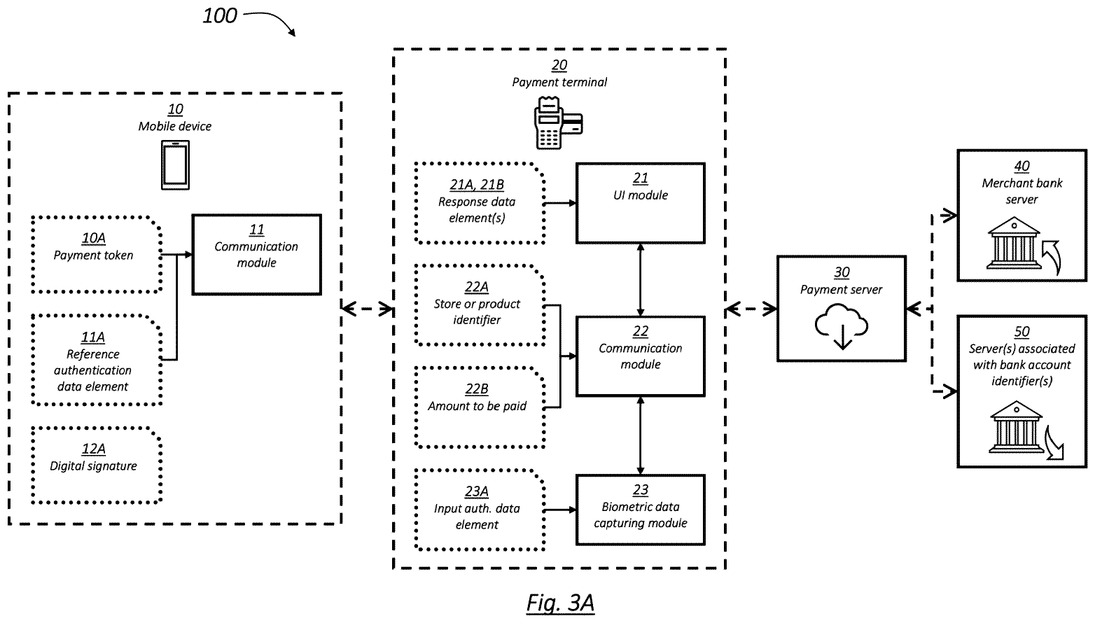

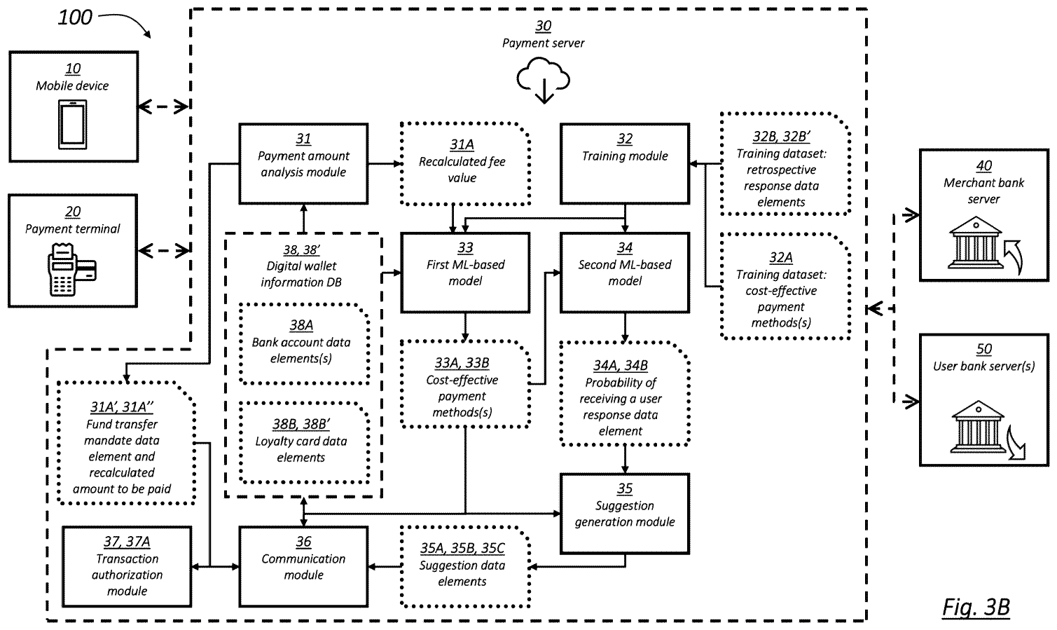

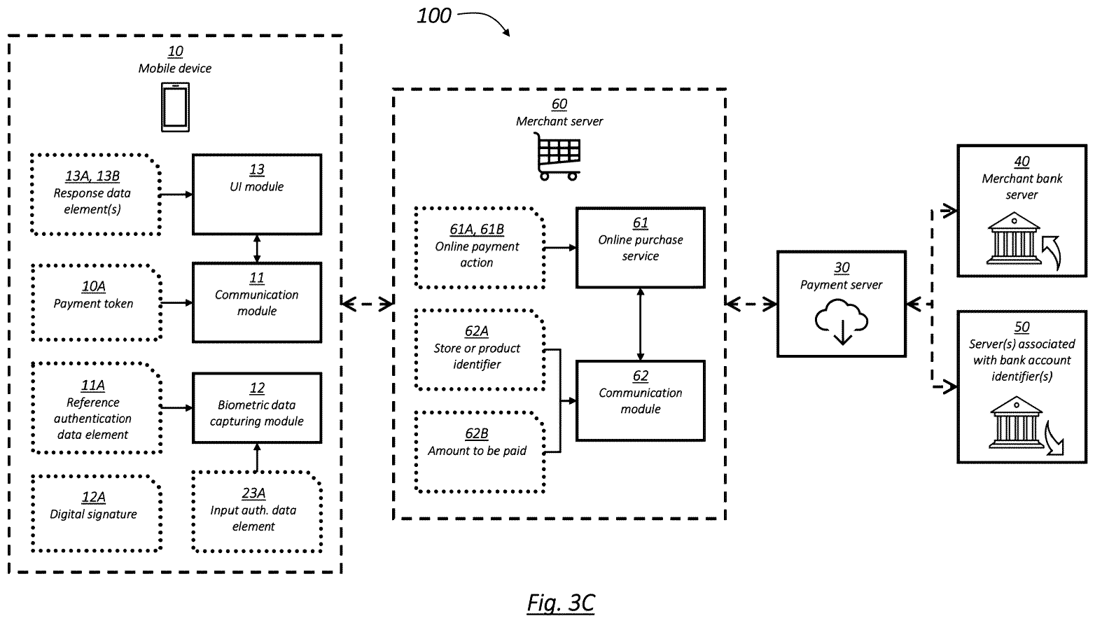

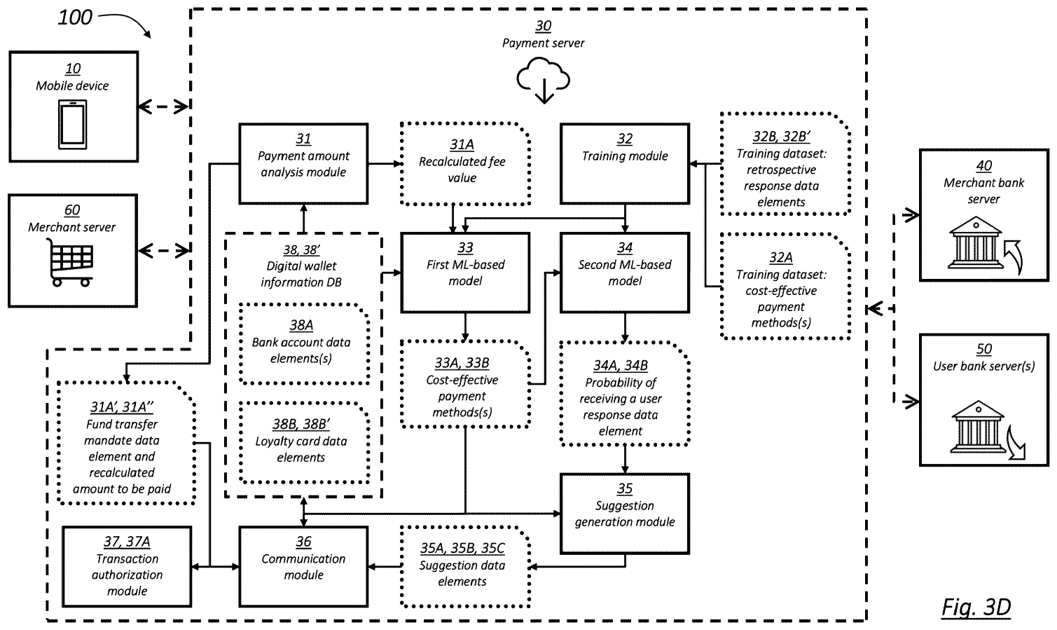

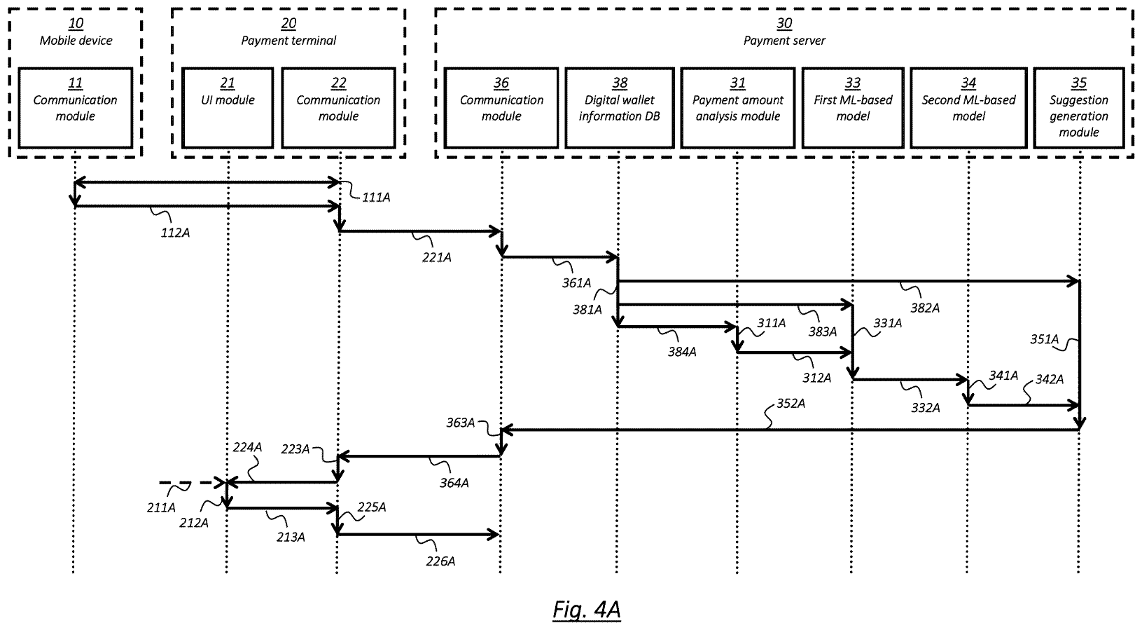

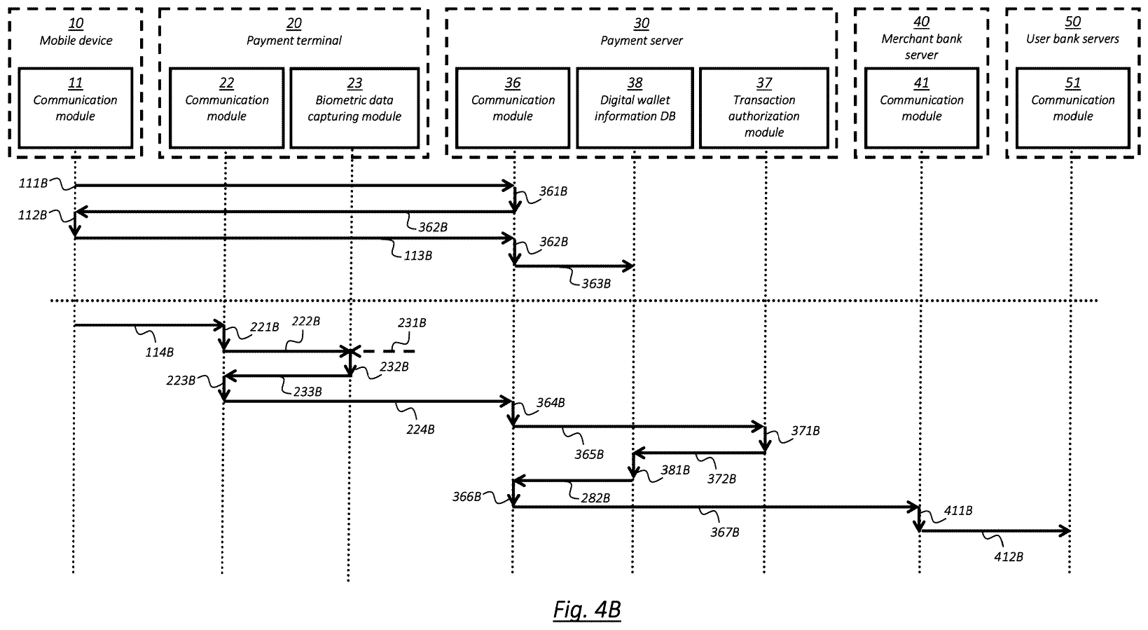

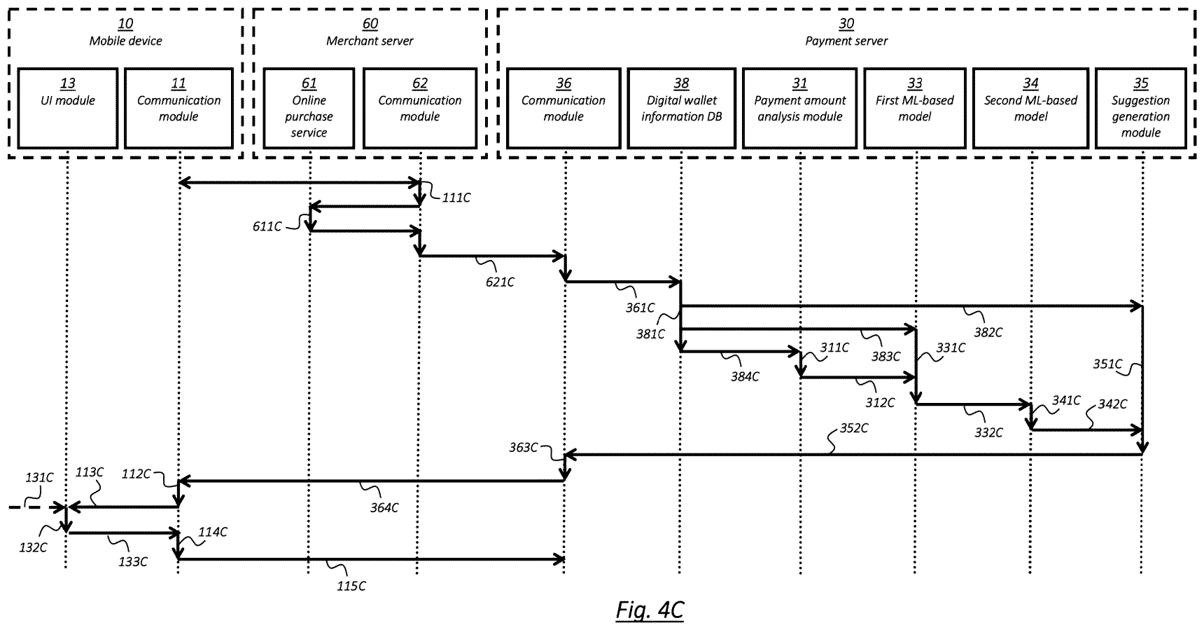

In step 1001, at least one processor (e.g., processor 2 shown in FIG. 2, e.g., a processor of mobile device 10 and a processor of payment terminal 20, shown in FIGS. 3A and 3B) may establish wireless connection between a payment terminal (e.g., payment terminal 20, shown in FIGS. 3A and 3B) and a mobile device (e.g., mobile device 10, shown in FIGS. 3A and 3B), said payment terminal being connected to a payment server (e.g., payment server 30, shown in FIGS. 3A and 3B). Step 1001 may be carried out by communication module 11, communication module 22 and communication module 36 (as described with reference to FIGS. 3A, 3B, 4A and 4B).

In step 1002, at least one processor (e.g., processor 2 shown in FIG. 2, e.g., a processor of mobile device 10 and a processor of payment terminal 20, shown in FIGS. 3A and 3B) may perform receiving, by the payment terminal from the mobile device via the established wireless connection, a payment token (e.g., payment token 10A, as shown in FIG. 3A). Step 1002 may be carried out by communication module 11 and communication module 22 (as described with reference to FIGS. 3A and 4A).

In step 1003, at least one processor (e.g., processor 2 shown in FIG. 2, e.g., a processor of payment server 30 and a processor of payment terminal 20, shown in FIGS. 3A and 3B) may perform receiving, by the payment server (e.g., payment server 30, shown in FIGS. 3A and 3B) from the payment terminal (e.g., payment terminal 20, shown in FIGS. 3A and 3B): (i) the payment token (e.g., payment token 10A, as shown in FIG. 3A), (ii) a store or product identifier (e.g., identifier 22A, as shown in FIG. 3A), and (iii) an amount to be paid (e.g., amount 22B to be paid, as shown in FIG. 3A). Step 1003 may be carried out by communication module 22 and communication module 36 (as described with reference to FIGS. 3A, 3B and 4A, 4B).

In step 1004, at least one processor (e.g., processor 2, shown in FIG. 2, e.g., a processor of payment server 30, shown in FIG. 3B) may perform retrieving, from a database stored on the payment server (e.g., digital wallet information database 38 stored in the memory module of payment server 30, shown in FIG. 3B), a digital wallet information (e.g., information 38′, as shown in FIG. 3B) comprising: one or more bank account data elements (e.g., bank account data elements 38A, as shown in FIG. 3B), and a loyalty card data element (e.g., loyalty card data elements 38B, as shown in FIG. 3B); said digital wallet information being associated with the received payment token (e.g., payment token 10A, as shown in FIG. 3A), and said loyalty card data element being further associated with the received store or product identifier (e.g., identifier 22A, as shown in FIG. 3A). Step 1004 may be carried out by communication module 36 and payment amount analysis module 31 (as described with reference to FIGS. 3B, 4A, and 4B).

In step 1005, at least one processor (e.g., processor 2, shown in FIG. 2, e.g., a processor of payment server 30, shown in FIG. 3B) may perform recalculating of the amount to be paid (e.g., amount 22B to be paid, as shown in FIG. 3A, and recalculated amount 31A″ to be paid, as shown in FIG. 3B), based on the retrieved loyalty card data element (e.g., loyalty card data element 38B, as shown in FIG. 3B). Step 1005 may be carried out by payment amount analyses module 31 (as described with reference to FIGS. 3B, 4A, and 4B).

In step 1006, at least one processor (e.g., processor 2, shown in FIG. 2, e.g., a processor of payment server 30, shown in FIG. 3B) may initiate the payment transaction, using: (i) the recalculated amount to be paid (e.g., recalculated amount 31A″ to be paid, as shown in FIG. 3B); and (ii) the retrieved one or more bank account data elements (e.g., bank account data elements 38A, as shown in FIGS. 3B, 4A, and 4B). Step 1006 may be carried out by communication modules 36, 41 and 51, and merchant bank server 40 and user bank server 50 (as described with reference to FIGS. 3B, 4A, and 4B).

It should be understood that the method embodiments described herein are not constrained by any particular orders of steps thereof. Furthermore, certain method embodiments may incorporate steps that may occur or be executed simultaneously.

Aspects of the method of FIG. 1A are further clarified with reference to FIGS. 2, 3A-3B, and 4A-4B.

Referring now to FIG. 1B, a flow diagram is presented, illustrating a method of initiating online payment transactions, according to certain embodiments of the present invention.

It shall be understood that although in many aspects the solution described above refers to POS-payment purchases, it provides an architecture that may be easily scaled-up, covering online purchases as well. In the present context, online purchases may refer to e-commerce, short for electronic commerce, also referred to as online shopping. It may cover buying and selling of goods and services through online platforms, including websites and mobile applications.

By being easily applicable to both online and POS payments, the suggested solution further contributes to the aforementioned technological improvement by decreasing complexity of integration into existing payment infrastructures.

Furthermore, same as with POS payments, the online payment transaction may be conducted in a more seamless and efficient manner, since, unlike the solutions known in the art, no additional actions are required at the customer's side to select and apply the desired loyalty card (e.g., to search for a number of a coupon and enter this number in a respective field on the merchant's web-site). The computational loads at the customer's side may also be reduced accordingly, as the suggested approach requires less interaction with the mobile device's user interface to perform the transaction. Thereby, the transaction becomes less time and power consuming.

In step 2001, at least one processor (e.g., processor 2 shown in FIG. 2, e.g., a processor of a merchant server 60, shown in FIGS. 3C, 3D and 4C) may receive, via an online purchase service, an online payment action (e.g., action 61A, as shown in FIG. 3C) indicating a request from a current user to initiate a payment transaction (e.g., request 61B, as shown in FIG. 3C). Step 2001 may be carried out by online purchase service 61 (as described with reference to FIGS. 3C, 3D and 4C).

In step 2002, at least one processor (e.g., processor 2 shown in FIG. 2, e.g., a processor of merchant server 60, shown in FIGS. 3C, 3D and 4C) may perform transmitting upon receiving the request from the current user, (i) a payment token (e.g., payment token 10A, as shown in FIG. 3C), (ii) a store or product identifier (e.g., identifier 62A, as shown in FIG. 3C), and (iii) an amount to be paid (e.g., amount 62B to be paid, as shown in FIG. 3C) to a payment server (e.g., payment server 30, shown in FIGS. 3C and 3D). Step 2002 may be carried out by communication modules 62 and 36 (as described with reference to FIGS. 3C, 3D and 4C).

In step 2003, at least one processor (e.g., processor 2, shown in FIG. 2, e.g., a processor of payment server 30, shown in FIG. 3D) may perform retrieving, from a database stored on the payment server (e.g., digital wallet information database 38 stored in the memory module of payment server 30, shown in FIG. 3D), a digital wallet information (e.g., information 38′, as shown in FIG. 3D) comprising: one or more bank account data elements (e.g., bank account data elements 38A, as shown in FIG. 3D), and a loyalty card data element (e.g., loyalty card data elements 38B, as shown in FIG. 3D); said digital wallet information being associated with the received payment token (e.g., payment token 10A, as shown in FIG. 3C), and said loyalty card data element being further associated with the received store or product identifier (e.g., identifier 62A, as shown in FIG. 3C). Step 2003 may be carried out by communication module 36 and payment amount analysis module 31 (as described with reference to FIGS. 3B, 3D, 4A, and 4C).

In step 2004, at least one processor (e.g., processor 2, shown in FIG. 2, e.g., a processor of payment server 30, shown in FIG. 3D) may perform recalculating of the amount to be paid (e.g., amount 62B to be paid, as shown in FIG. 3C, and recalculated amount 31A″ to be paid, as shown in FIG. 3D), based on the retrieved loyalty card data element (e.g., loyalty card data element 38B, as shown in FIG. 3D). Step 2004 may be carried out by payment amount analyses module 31 (as described with reference to FIGS. 3B, 3D, 4A, and 4C).

In step 2005, at least one processor (e.g., processor 2, shown in FIG. 2, e.g., a processor of payment server 30, shown in FIG. 3B) may initiate the payment transaction, using: (i) the recalculated amount to be paid (e.g., recalculated amount 31A″ to be paid, as shown in FIG. 3D); and (ii) the retrieved one or more bank account data elements (e.g., bank account data elements 38A, as shown in FIG. 3D). Step 2005 may be carried out by communication modules 36, 41 and 51, and merchant bank server 40 and user bank server 50 (as described with reference to FIGS. 3B, 3D, and 4B).

Referring now to FIG. 2, a block diagram is represented, depicting a computing device which may be included in the system for initiating payment transactions, according to certain embodiments.

FIG. 2 illustrates only a non-exclusive example of computing device 1, and many other example embodiments of computing device 1 may be used herein.

As shown, computing device 1 may include one or more processor(s) 2 (or controller(s)) (e.g., Central Processing Unit (CPU), a chip etc.), memory module 3, operating system (OS) 4, program instructions 5, input devices 6, output devices 7, communication devices 8. Processor(s) 2 may be distributed across multiple computing devices 1. Each of components 2-8 may be interconnected via one or more busses for inter-component communications. Processor 2 may be configured to implement functionality and/or process instructions for execution within computing device 1. Processor 2 may be capable of processing instructions 5 stored in memory module 3, thereby carrying out the method described herein. In accordance with embodiments of the invention, the system for initiating payment transactions may include multiple computing devices 1, each acting as a respective component of the system (e.g., mobile device, server, payment terminal etc.), wherein each of the computing devices 1 may have one or more processors 2, memory modules 3, program instructions 5, input devices 6 and output devices 7.

Operating system 4 may represent a program instructions segment that is configured to, when implemented by at least one processor (e.g., processor 2), manage and control hardware resources of computing device 1 (e.g., memory module 3, input and output devices 6 and 7). Operating system 4 is configured to provide essential functionalities such as process scheduling, memory management, file system access, and network communication. Operating system 4 may be configured to act as an intermediary between program instructions 5 and the underlying hardware, enabling efficient execution of tasks, user interaction, and overall system stability.

Memory module 3 may be configured to store various data used by at least one component (e.g., processor 2 or input and output devices 6 and 7) of the computing device 1. The various data may include, for example, software (e.g., program instructions 5) and input data or output data for a command related thereto. By accessing data stored by memory module 3, processor 2 may be configured to execute program instructions 5 to implement aspects of the method for initiating payment transactions, as described herein. Memory module 3 may include Random Access Memory (RAM), Read-Only Memory (ROM), cache memory, Hard Disk Drive (HDD), Solid State Drive (SSD), virtual memory, flash memory, registers etc., or combination thereof.

Program instructions 5 may be an executable program code, e.g., acting as a stand-alone application, an application comprising interconnected server and terminal parts, an Application Program Interface (API) module, scripts integrated into other applications etc. Program instructions 5 may be dedicated to being executed by processor 2 to implement various operations using input and output devices 6 and 7, memory module 3 etc., using operating system 4. When being executed, program instructions 5 may be configured to implement various steps of the claim method of initiating payment transaction, as further discussed in greater detail.

Input devices 7 may receive controlling signal, command or data to be used by another component (e.g., processor 2) of the device 1, from the outside of the device 1 (e.g., from a user). Input devices 7 may include, for example, a microphone, a mouse, a keyboard, keys (e.g., buttons), a digital pen (e.g., a stylus pen), a touchscreen, a camera (having 2D or 3D capturing means, e.g., a depth camera), a fingerprint scanner etc., connected to computing device 1 using standard or specifically designed communication interfaces. Output devices 8 may output (transmit) signals, commands or data to be received and used by other computing devices 1 or to be provided to the user (e.g., as a sound, image, video, printed data etc.). Output devices 8 may include display (e.g., touchscreen), sound speaker, printer etc., connected to computing device 1 using standard or specifically designed communication interfaces.

Communication module 8 may be configured to support establishing a direct (e.g., wired) communication channel or a wireless communication channel between computing device 1 and other computing devices 1 and performing communication via the established communication channel. Communication module 8 may be or may include a short-range wireless communication module (e.g., using Bluetooth™, wireless-fidelity (Wi-Fi), or infrared data association (IrDA), Near-Field Communication (NFC) module etc.), a long-range communication module (such as a cellular communication module, e.g., using a cellular network, e.g., a fifth-generation (5G) network), a computer network module (e.g., using Local Area Network (LAN), Wide Area Network (WAN)), or the Internet) a Global Navigation Satellite System (GNSS) communication module, a power line communication (PLC) module, etc.

Reference is now made to: FIG. 3A depicting aspects of mobile device 10 and payment terminal 20 of system 100 for initiating payment transactions, according to certain embodiments; FIG. 3B depicting aspects of payment server 30 of system 100 for initiating payment transactions, according to certain embodiments; FIG. 4A depicting aspects of a cost-effective payment method determination, as performed by system 100, according to certain embodiments; and FIG. 4B depicting aspects of payment token and fund transfer mandate data element generation and usage, as well as aspects of a payment transaction authorization, as performed by system 100, according to certain embodiments.

As shown in FIGS. 3A-3D, and 4A-4C, arrows may represent flow of one or more data elements to and from system 100 or among modules or elements of system 100. It is to be acknowledged that certain arrows may have been intentionally omitted for the sake of clarity. According to certain embodiments of the invention, system 100 may be implemented as a software module, a hardware module, or a combination thereof. System 100 may include computing devices such as computing device 1 shown in FIG. 2, that may be adapted to execute one or more modules of program instructions (e.g., program instructions 5 of FIG. 2) to perform steps of the claimed method of initiating payment transactions.

As can be seen in FIGS. 3A and 3B, in certain embodiments, system 100 may include mobile device 10 of a customer (a user), payment terminal 20 of a store (a merchant), payment server 30, merchant bank server 40 (e.g., involved into maintenance of a merchant's bank account) and server(s) 50 associated with bank account identifiers of a customer (e.g., user's bank servers, involved into maintenance of customer's bank accounts, respectively).

In certain embodiments, mobile device 10 may include communication module 11. In certain embodiments, payment terminal 20 may include communication module 22. In certain embodiments, payment server 30 may include communication module 36. In certain embodiments, merchant bank server 40 may include communication module 41. In certain embodiments, user bank server 50 may include communication module 51. In certain embodiments, communication modules 11 and 22 may be configured to establish NFC communication therebetween (e.g., via procedure 111A, shown in FIG. 4A). The indicated NFC communication may, for example, be performed in the same manner as it is performed by currently utilized and known-in-the-art payment systems. Communication module 22 may be communicatively connected to communication module 36 via standard or specifically designed computer network means. Communication module 36 may be communicatively connected to communication modules 41 and 51.

In certain embodiments, communication module 11 may be further configured to transfer, to communication module 22 via the established wireless connection (e.g., via procedure 112A shown in FIG. 4A), payment token 10A. As discussed above, in certain embodiments, communication modules 11 and 22 may be configured to perform payment token 10A transmission, same as it is supported by currently deployed payment systems.

In certain embodiments, payment token 10A may be a numerical or alphanumerical identification code.

In certain embodiments, communication module 22 may be further configured to transfer, to communication module 36 (e.g., via procedure 221A shown in FIG. 4A), payment token 10A, store or product identifier 22A, and an amount 22B to be paid. E.g., store identifier 22A may be generated by payment terminal 20 in advance, upon installation of payment terminal 20 in the respective store, and product identifier 22A may be obtained when scanning a respective product bar-code at a cash register of the store. E.g., amount 22B to be paid may also be obtained when scanning the respective product bar-code at the cash register, as currently implemented in the art.

In certain embodiments, payment server 30 may store digital wallet information database 38. Payment server 30 may be further configured to store, in database 38, digital wallet information 38′ in association with the received payment token 10A. Digital wallet information 38′ may include bank account data elements 38A and loyalty card data elements 38B. Loyalty card data elements 38B may be stored in further association (in addition to association with payment token 10A) with store or product identifiers (e.g., that is, it may be indicated that specific loyalty card is issued by corresponding store and may be accordingly applied when purchasing products therewith). Loyalty card data elements 38B may include loyalty card data element 38B′ associated with store or product identifier 22A, received from payment terminal 20.

In certain embodiments, communication module 36 may be configured to generate request (e.g., procedure 361A, shown in FIG. 4A) to retrieve, from digital wallet information database 38, digital wallet information 38′ comprising: bank account data elements 38A, based on the association with payment token 10A, and loyalty card data element 38B′, based on the association with payment token 10A and store or product identifier 22A. Thereby, by using store or product identifier 22A, server 30 may be configured to select the desired loyalty card data element (e.g., loyalty card data element 38B′) associated therewith from the entire plurality of loyalty card data elements stored in digital wallet information database 38 in association with payment token 10A of a particular customer.

In certain embodiments, bank account data elements 38A may include bank account identifiers, such as, e.g., a credit card number associated with an authorized user of mobile device 10; a billing address associated with the authorized user of mobile device 10; and a bank account number associated with the authorized user of mobile device 10.

In certain embodiments, bank account data elements 38A may further include fee values associated with said bank account identifiers, e.g., Interest Rate (IRF) and/or Annual Percentage Rate (APR), etc.

Payment server 30 may be configured to retrieve said information 38′ (procedure 381A, shown in FIG. 4A), upon request (procedure 361A, shown in FIG. 4A).

In certain embodiments, payment server 30 may further include payment amount analysis module 31. Payment amount analysis module 31 may be configured to receive information 38′ (e.g., procedure 384A, as shown in FIG. 4A). Payment amount analysis module 31 may be further configured to recalculate amount 22B to be paid, based on the retrieved loyalty card data element 38B′ (e.g., procedure 311A, as shown in FIG. 4A), and thereby output recalculated amount to be paid 31A″.

The following description relates to embodiments of the present invention including multiple additional functionalities of system 100, which become enabled due to the application of the general concept of the present invention. However, it shall be appreciated that, in certain embodiments, server 30 may be configured to proceed with initiation of the payment transaction, simply using recalculated amount to be paid 31A″ and retrieved one or more bank account data elements 38A (e.g., credit card number of a credit card which were selected by the user as a default for payments), without performing any additional functionalities described further below. In such embodiments, payment server 30 may be further configured to communicate the credit card number of the customer and recalculated amount to be paid 31A″ with merchant bank server 40 and/or user bank server 50, to further proceed with payment transaction in a same manner as it is performed in known-in-the-art systems (same, as if the respective loyalty card were applied manually and the amount to be paid was recalculated at the payment terminal).

As for other embodiments, payment server 30 may include machine-learning (ML)-based model 33 (also referred herein as “first” ML-based model). In certain embodiments, ML-based model 33 may be respectively pretrained, upon receiving the retrieved digital wallet information (e.g., digital wallet information 38′), an amount to be paid (e.g., amount to be paid 22B), and a store or product identifier (e.g., store or product identifier 22A), to calculate one or more cost-effective payment methods each comprising at least one of: (i) a combined application of a specific bank account identifier of the one or more bank account identifiers and a specific loyalty card data element of the plurality of loyalty card data elements; (ii) a combined application of a specific bank account identifier of the one or more bank account identifiers and a specific new loyalty card data element; (iii) a combined application of a specific new bank account or a specific new credit card data element and a specific loyalty card data element of the plurality of loyalty card data elements; (iv) a combined application of a specific new bank account or a specific new credit card data element and a specific new loyalty card data element; (v) credit, and/or loan, and/or split payments options; and (vi) payment options involving cryptocurrencies and/or central bank digital currencies (CBDC). ML-based model 33 may be pretrained using known-in-the-art machine learning and artificial intelligence techniques. ML-based model 33 may be pretrained based on a dataset (e.g., training dataset 32A) comprising a plurality of training samples including: (i) as an input value, a digital wallet information (different combinations bank account identifiers associated with known banks and a loyalty card data elements associated with known stores and products), an amount to be paid (represented in a significant range of values) and a store or product identifier (accordingly, covering different known stores and products, optionally, grouped by type); and (ii) as a respective desired output value-a desired cost-effective payment method (comprising aforementioned combinations, which may be based on precalculated cost-effective solutions, as well as on statistically accumulated preferences of other customers).

In certain embodiments, payment server 30 may further include training module 32. Training module 32 may be configured to: (i) acquire (from third-party providers) and accumulate information about new bank account identifiers (e.g., credit card data elements) and loyalty card data elements, new store or product identifiers and new cost-effective payment methods; (ii) form training dataset 32A, based on the acquired information; and (iii) periodically retrain ML-based model 33 using training dataset 32A to keep it up to date.

In certain embodiments, to further enhance the reliability of system 100 in terms of providing cost-effective methods of higher relevance, ML-based model 33 may be pretrained using location-oriented (e.g., country-, region- or city-oriented) dataset(s), corresponding to the specific location where the customer lives or where system 100 is deployed. In some further embodiments, system 100 may be configured to retrain ML-based model 33, or, alternatively, to select a desired ML-based model 33 of a plurality of respectively pretrained ML-based models 33, based on at least one of: (a) the location where system 100 is deployed; (b) the location where the current payment transaction takes place; and (c) the content of the digital wallet of the specific customer (e.g., by determining that a specific customer has bank account identifiers mostly associated with banks of a specific country/region/city, and thereby selecting specific ML-based model 33 or retraining ML-based model 33 so as to correspond to preferences of customers of a respective country/region/city).

In certain embodiments, payment server 30 may be further configured to infer (e.g., procedure 383A, as shown in FIG. 4A) ML-based model 33 on: retrieved digital wallet information 38′; amount to be paid 22B; and store or product identifier 22A, to calculate (e.g., procedure 331A, as shown in FIG. 4A) one or more cost-effective payment methods 33A (as discussed above).

In certain embodiments, ML-based model 33 may be further configured to calculate (e.g., within procedure 331A, as shown in FIG. 4A), for each of cost-effective payment methods 33A, confidence metric value 33B, representing a probability of a respective cost-effective payment method 33A of one or more cost-effective payment methods 33A to have the highest cost effectiveness.

In certain embodiments, payment amount analysis module 31 may be configured to perform the following. For each bank account data element 38A, payment amount analysis module 31 may be configured to: (i) calculate a frequency of performing payment transactions using a respective bank account identifier (e.g., using accumulated transaction history, which may be stored on payment server 30 or provided by a third-party provider); and (ii) recalculate a respective fee value (e.g., IRF and/or APR, as described above), based on the calculated frequency (e.g., within procedure 311A, shown in FIG. 4A). Payment amount analysis module 31 may be further configured to transfer the recalculated fee values (calculated to each bank account identifier, respectively) to ML-based model 33. Accordingly, in certain embodiments, payment server 30 may be further configured to infer ML-based model 33 further on the recalculated fee values, to calculate the one or more cost-effective payment methods 33A (that is, the recalculated fee values may be used as an input to ML-based model 33A in addition to other input data discussed above).

Said embodiment provides for stimulating customers (e.g., by suggesting lower APR on credit and lower IRF for processing) to make purchases in seasons when sales are low. Said embodiment also provides for encouraging the use of bank account identifiers that have been underutilized for an extended period. By providing such functionality in an automatic and intelligent manner, an additional contribution into the improvement of the aforementioned technological field is being made.

In certain embodiments (not shown in figures), payment server 30 may be further configured to initiate the payment transaction further based on a first cost-effective payment method of one or more cost-effective payment methods 33A, said first cost-effective payment method having a highest calculated confidence metric value.

In some additional or alternative embodiments, payment server 30 may further include ML-based model 34 (also referred herein as “second” ML-based model). ML-based model 34 may be respectively pretrained, upon receiving the calculated one or more cost-effective payment methods (e.g., one or more cost-effective payment methods 33A), to calculate, for each of the one or more cost-effective payment methods, a probability of receiving a user response data element (a user response when enquiring confirmation of a cost-effective payment method, explained further below) respectively representing one of (a) a confirmation of selecting a respective cost-effective payment method of the one or more cost-effective payment methods (e.g., one or more cost-effective payment methods 33A); and (b) a declination of selecting the respective cost-effective payment method of the one or more cost-effective payment methods (e.g., one or more cost-effective payment methods 33A).

ML-based model 34 may be pretrained using known-in-the-art machine learning and artificial intelligence techniques. In certain embodiments, ML-based model 34 may be pretrained based on a dataset (e.g., training dataset 32B) comprising a plurality of training samples including: (i) as an input value, a plurality of payment methods (e.g., different combinations of payment cards, loyalty cards, credit, and/or loan, and/or split payments options etc.); and (ii) as a respective desired output value-a respective user response data element (confirmation or declination of the respective payment method). In certain embodiments, ML-based model 34 may be pretrained based on the dataset (e.g., training dataset 32B) formed using retrospectively accumulated data of payment methods that specific user (customer) applied when making purchases. In certain embodiments, system 100 may be configured to accumulate response data elements (explained further below) received by user input in each transaction and iteratively retrain ML-based model 34 based thereon, in order to keep system 100 relevant to most recent user's preferences. Accordingly, in certain embodiments, training module 32 may be further configured to receive (e.g., accumulate or obtain from a third-party provider) a plurality of retrospective user response data elements, each representing one of (a) a confirmation of selecting the respective cost-effective payment method of the one or more cost-effective payment methods; and (b) a declination of selecting the respective cost-effective payment method of the one or more cost-effective payment methods, said retrospective user response data elements being obtained during previous payment transactions; and train ML-based model 34 to calculate probability 34A of receiving upcoming user response data elements (e.g., data elements 34B), each representing one of (a) a confirmation of selecting the respective cost-effective payment method of the one or more cost-effective payment methods (e.g., cost-effective payment methods 33A); and (b) a declination of selecting the respective cost-effective payment method of the one or more cost-effective payment methods (e.g., cost-effective payment methods 33A), by using the plurality of retrospective user response data elements as a supervisory dataset.

In certain embodiments, payment server 30 may be further configured to infer (e.g., procedure 332A, as shown in FIG. 4A) ML-based model 34 on the calculated one or more cost-effective payment methods (e.g. payment methods 33A), to calculate (e.g., procedure 341A, as shown in FIG. 4A), for each of the one or more cost-effective payment methods, probability 34A of receiving user response data element 34B (representing a confirmation or a declination of selecting respective cost-effective payment method 33A, as discussed above).

In certain embodiments, system 100 may further include suggestion generation module 35. Suggestion generation module 35 may be configured to receive digital wallet information 38′ (e.g., procedure 382A, as shown in FIG. 4A). In certain embodiments, suggestion generation module 35 may be further configured to receive amount 22B to be paid and store or product identifier 22A. Suggestion generation module 35 may be further configured to generate suggestion data element 35A (also referred herein as the “first” suggestion data element), representing a suggestion of obtaining at least one of: new loyalty card data elements; new credit card data elements; and new bank accounts; based on at least one of: digital wallet information 38′; amount 22B to be paid; and store or product identifier 22A (e.g., procedure 351A, as shown in FIG. 4A). E.g., suggestion generation module 35 may be configured to analyze the content of the digital wallet (the available payment card and loyalty card data elements), amount 22B to be paid and identifier 22A, and e.g., determine that the respective digital wallet does not include a loyalty card of the respective store (identified by identifier 22A), and, accordingly, generate suggestion data element 35A representing a suggestion of obtaining a new loyalty card data elements (representing loyalty card of the respective store), e.g., provided that amount 22B is higher than a certain threshold (that is, the customer is purchasing an expensive product and the store may suggest him obtaining a loyalty card for making discount purchases in future). In another example, suggestion generation module 35 may determine that there is a beneficial option of using a credit card of a specific bank when making purchases in a specific store (identified by identifier 22A), and that the digital wallet does not include respective credit card data elements (representing such credit cards). Suggestion generation module 35 may be accordingly configured to generate suggestion data element 35A representing a suggestion of obtaining a new credit card data element representing the credit card of the respective bank. In certain embodiments, the information of new loyalty cards, credit cards and bank accounts may be obtained by payment server 30 from respective third-party providers on a regular basis, e.g., via network updates.

In certain embodiments, suggestion generation module 35 may be further configured to receive information about cost-effective payment methods 33A and respective probabilities 33B (e.g., procedure 342A, as shown in FIG. 4A). Suggestion generation module 35 may be further configured to generate suggestion data element 35B (e.g., also referred herein as “second” suggestion data element) representing a suggestion of selecting one of cost-effective payment methods 33A. In certain embodiments, suggestion generation module 35 may be configured to generate suggestion data element 35B in accordance with probability 33B, e.g., generate a list of cost-effective payment methods sorted by probability 33B (e.g., so that payment methods having higher probability 33B appear first), or to provide only cost-effective payment method having the highest probability 33B).

Additionally, in certain embodiments, suggestion generation module 35 may be further configured to receive probability 34A of receiving user response data element 34B (e.g., procedure 342A, as shown in FIG. 4A). Suggestion generation module 35 may be further configured to generate suggestion data element 35B, based on the calculated probability 34A. E.g., suggestion generation module 35 may be configured to generate suggestion data element 35B, representing a suggestion of selecting cost-effective payment methods 33A having probability 34A higher than a certain predefined threshold (e.g., the options most likely to be relevant for the individual user). In another non-exclusive example, when considering two cost-effective payment methods 33A, wherein the first one has probability 33B higher than the second one, however the second one has probability 34A higher than the first one, cost-effective payment methods 33A may be sorted so that the second one is represented first in the list included in suggestion data element 35B.

In certain embodiments, suggestion generation module 35 may be further configured to transfer suggestion data elements 35A and 35B to communication module 36, which in turn may be configured to retransfer suggestion data elements 35A and 35B to payment terminal 20, e.g., via communication module 22 (e.g., procedures 352A, 363A, and 364A, as shown in FIG. 4A).

In certain embodiments, payment terminal 20 may further include UI module 21 (e.g., touch screen and a respective software, including program instructions upon execution of which said touch screen may represent various output information and receive input information from a user). Communication module 22 may be further configured to transfer suggestion data elements 35A and 35B to UI module 21 (e.g., procedures 223A, and 224A, as shown in FIG. 4A).

In certain embodiments, payment terminal 20 may be further configured to provide, via UI of UI module 21, suggestion data elements 35A and 35B (e.g., procedure 212A, as shown in FIG. 4A). In certain embodiments suggestion data elements 35A and 35B may be provided in the form of messages on the display of UI module 21, containing text, images, video, and virtual buttons for receiving user input (confirmation or declination) etc. Accordingly, in certain embodiments, payment terminal 20 may be further configured to receive, via UI of UI module 21, current user response data element 21A representing one of (a) a confirmation of selecting the one of cost-effective payment methods 33A; and (b) a declination of selecting the one of cost-effective payment methods 33A (e.g., procedure 211A, as shown in FIG. 4A). In certain embodiments, payment terminal 20 may be optionally further configured to receive, via UI of UI module 21, current user response data element 21B representing one of (a) a confirmation of the suggestion of new loyalty card data elements, new credit card data elements, and new bank accounts; and (b) a declination of the suggestion of new loyalty card data elements, new credit card data elements, and new bank accounts.

In accordance with the described above, in certain embodiments, UI module 21 may be further configured to provide suggestion data element 35B further based on probability 34A, e.g., by providing a list of cost-effective payment methods 33A sorted by probability 34A to represent cost-effective payment methods 33A that are most likely to be confirmed on top of the list; or by providing only those cost-effective payment methods 33A that have probability 34A higher than a certain predefined threshold; or simply providing cost-effective payment method 33A that has the highest probability 34A.

In certain embodiments, communication module 22 may be further configured to receive, from UI module 21, current user response data elements 21A and 21B (e.g., procedure 213A, as shown in FIG. 4A) and transfer current user response data elements 21A and 21B to communication module 36 (e.g., procedures 225A and 226A shown in FIG. 4A).

It shall be appreciated that in certain alternative embodiments (not shown in Figures), communication of the aforementioned suggestions (suggestion data elements 35A, 35B and 35C) to the user may be performed via UI of mobile device 10 (instead of UI of payment terminal 20, as described above). That is, communication module 36 may be configured to transfer suggestion data elements 35A, 35B and 35C to communication module 11 directly (e.g., via Internet connection). Mobile device 10, accordingly, may be configured to provide to the user, via UI of mobile device 10, respective suggestions, and obtain, from the user, respective response data elements 21A and 21B. Communication module 11 may be further configured to transfer response data elements 21A and 21B to communication module 36 directly. Said communication may be performed via a dedicated software application installed on mobile device 10, having a personal account for each registered user, said account being associated with payment token 10. Information about the personal account may be included in digital wallet information 38′. Payment server 30 may be further configured to retrieve the information about the personal account and establish the abovementioned communication with mobile device 10 using the information about the personal account. This way, payment server 30 may know “how” to reach the required user.

This alternative embodiment can further contribute to the improvement of the respective technological field by efficiently leveraging existing technical infrastructure. Specifically, in such implementations, the practical deployment of system 100 does not necessitate substantial modernization of payment terminals (POS-terminals). Instead, it seamlessly utilizes the user interface (UI) of mobile devices to offer the aforementioned suggestions. Consequently, the deployment process for system 100 is further streamlined.

The same approach is applicable for online purchases using the suggested system 100, as explained with reference to FIGS. 3C, 3D and 4C.

Payment server 30 may be further configured to initiate the payment transaction further based on the received current user response data elements 21A and 21B, i.e., may use the confirmed cost-effective payment method 33A (a combination of a specific payment card or bank account and a specific loyalty card, as confirmed by the user). The initiation of the payment transaction is explained further below using sequence diagram of FIG. 4B.

In certain embodiments, training module 32 may be further configured to supplement the supervisory dataset (e.g., training dataset 32B) with the received current user response data element 21A; and retrain ML-based model 34 using the supplemented supervisory dataset (e.g., supplemented training dataset 32B′).

In certain embodiments, payment server 30 may be further configured to accumulate transaction history (e.g., including information about cost-effective payment method 33A used, respective store or product identifier 22A, recalculated amount to be paid 31A″ etc.). Payment server 30 may be further configured to analyze the transaction history (e.g., a plurality of store or product identifiers associated with previous transactions) to determine relevant products that the respective customer may find interesting to purchase.

Accordingly, in certain embodiments, suggestion generation module 35 may be further configured to generate suggestion data element 35C (also referred herein as “third” suggestion data element) representing a suggestion of purchasing the determined new product, based on at least one of: the store or product identifier; and a plurality of store or product identifiers associated with previous transactions; and further based on the information on new products (e.g., obtained from a third-party provider, e.g., from a server of the respective store, determined by identifier 22A).

E.g., payment server 30 may determine, based on the transaction history, that the respective customer buys each year, at a certain time of the year, a certain product. Then, when the customer makes new purchase at that certain time, payment server 30 may determine, based on the current product identifier 22A, that the current product is not similar to that certain product, therefore, the suggestion of that certain product may be still relevant to that user. Accordingly, suggestion generation module 35 may be configured to generate suggestion data element 35C, representing a suggestion of buying that certain product. However, once payment server 30 determines, based on current product identifier 22A, that the current product is similar to that certain product, payment server 30 may stop suggesting that certain product (assuming that the customer has already bought it or is buying it now).

In other embodiments, payment server 30 may simply determine, based on current store or product identifier 22A, products that are relevant to the current product, and generate suggestion data element 35C, accordingly representing suggestion of buying the determined relevant products.

It shall be appreciated by the person skilled in the art that the abovementioned determination of similarity or relevance of products may be performed using known machine-learning and artificial-intelligence methods. The abovementioned examples of generating suggestion data element 35C are provided for the purpose of clarity only and shall not be considered in any respect limiting the scope of the present invention.

Suggestion generation module 35 may be further configured to transfer suggestion data element 35C to payment terminal 20 (e.g., via procedures 352A, 363A, 364A, 223A, shown in FIG. 4A). UI module 21 may be further configured to receive suggestion data element 35C from communication module 22. Payment terminal 20 may be further configured to provide, via user interface of UI module 21, suggestion data element 35C. In certain embodiments, suggestion data element 35C serves as additional contextual information for the user, intending to inform the user about relevant products without expecting a response in return.

Referring additionally to FIG. 4B, aspects of user authentication and further aspects of the payment transaction initiation are discussed in detail.

As known, in conventional payment systems, payment terminal outputs the customer's payment credentials (e.g., credit card data or conventional payment token uniquely linked the credit card data) and the final amount to be paid, which will be withdrawn from the customer's bank account and transferred to merchant's bank account. In contrast to that, in the present system (e.g., system 100), the payment credentials are determined by the payment server (e.g., when determining cost-effective payment methods 33A by payment server 30). Additionally, the amount to be paid 22B is also recalculated by payment server 30. In the current system, the process of determining the customer's payment credentials and calculating the final amount to be paid has been moved deeper into the computational flow, by being shifted from the payment terminal to the payment server. As a result, the following additional aspects of the payment architecture are suggested in order to enhance the implementation of the invention.

Accordingly, it is suggested herein to use a fund transfer mandate data element (e.g., fund transfer mandate data element 31A′, shown in FIG. 3B).

In certain embodiments, fund transfer mandate data element 31A′ may be a data element providing permission to request, from one or more user bank servers associated with a respective retrieved one or more bank account identifiers (e.g., user bank server(s) 50, associated with bank account identifiers, retrieved from the respective digital wallet and, e.g., indicated in the determined cost-effective payment method 33A, that was confirmed by the user via the respective current user response data element 21A), a fund transfer to a merchant bank account (e.g., account the information about which is stored in merchant bank server 40), according to the recalculated amount 31A″ to be paid.

In certain embodiments, e.g., when the user performs registration in system 100 for the first time (as a new user), system 100 may be configured to create fund transfer mandate data element 31A′ that will be further used in payment transactions. E.g., in certain embodiments, mobile device 10 may be configured to receive, from payment server 30, a fund transfer template data element (not shown in figures)—a “blank” data structure that will be further filled with the required data (amount to be paid, payment credentials of the customer, as indicated in the determined and confirmed cost-effective payment method 33A) for each relevant payment transaction.

In certain embodiments, at the time of the first registration, system 100 may be configured to provide, to mobile device 10 of the new user, payment token 10A which will be further used to identify user's digital wallet, as described above.

E.g., as shown in FIG. 4B, communication module 11 may send a request to generate the fund transfer template data element and payment token 10A to communication module 36, e.g., via Internet connection, using a dedicated software application installed on mobile device 10. Communication module 36 may be further configured to generate the fund transfer template data element and payment token 10A (e.g., via procedure 361B, shown in FIG. 4B), based on the request. Communication module 36 may be further configured to transfer fund transfer template data element and payment token 10A to communication module 11 (e.g., via procedure 362B, shown in FIG. 4B). In certain embodiments, communication module 11 may be further configured to sign the fund transfer template data element using a digital signature of the authorized user of the mobile device, thereby generating fund transfer mandate data element 31A′ (e.g., via procedure 112B, shown in FIG. 4B). Communication module 11 may be further configured to transfer the generated fund transfer mandate data element 31A′ to communication module 36 (e.g., via procedure 113B, shown in FIG. 4B). Communication module 36 may be further configured to transfer fund transfer mandate data element 31A′ to digital wallet information database 38, to store data element 31A′ in the digital wallet of the respective customer, that is in association with payment token 10A (e.g., procedures 362B and 363B).

As for the aspects of user authorization, in certain embodiments, mobile device 10 may store reference authentication data element 11A, uniquely identifying the authorized user of mobile device 10. In certain embodiments, reference authentication data element 11A may be generated, based on user biometric data (fingerprint scan, face image, 3D face map etc.), or in other, more conservative embodiments, may represent an alphanumerical code. Reference authentication data element 11A may be generated in advance to performing the payment transaction, e.g., when the user performs registration in system 100 for the first time (as a new user). In certain embodiments, reference authentication data element 11A may be stored exclusively in the memory of mobile device 10. This approach reduces the chances of it being stolen or compromised, thereby enhancing security.

In certain embodiments, after the first-time registration is performed, the following processing fund transfer mandate data element 31A′ and reference authentication data element 11A may take place during each subsequent payment transaction.

In certain embodiments, communication module 20 may be configured to receive, from communication module 11 via the established wireless connection (e.g., using NFC protocol, as described above), reference authentication data element 11A (e.g., via procedure 114B, shown in FIG. 4B, or procedure 112A, shown in FIG. 4A). It shall be understood that the transmission of reference authentication data element 11A from mobile device 10 to payment terminal 20 may be performed within a single data transmission package with payment token 10A, that is within procedure 112A, shown in FIG. 4A. It is shown herein as a separate process in order to clarify user authorization procedure, however, in certain embodiments, data transmission related to the user authorization may be transmitted together with other data described with reference to FIG. 4A (e.g., payment token 10A, store or product identifier 22A, amount 22B to be paid etc.).

In certain embodiments, payment terminal 20 may include an input module for entering input authentication data element 23A by the user. Input authentication data element 23A will further be compared with reference authentication data element 11A to perform user authorization, as explained in detail further below. In certain embodiments, reference authentication data element 11A and input authentication data element 23A may represent biometric data of the authorized user and the current user, respectively, and said input module may be biometric data capturing module 23 (e.g., may include fingerprint scanner, camera etc.).

It shall be understood that, in the context of the present disclosure, the following two terms are used to describe the customer (the user of mobile device 10) depending on his authorization status: “an authorized user” and “a current user”. “A current user” refers to a user who has not passed the authorization procedure yet. It shall also be understood that, for security reasons, the authorization procedure may be a required step in order to proceed with a payment transaction (same as in conventional systems). “An authorized user” refers to a user which has passed the authorization procedure (e.g., has confirmed his identity) and is considered a person allowed to make payments using the content of the respective “digital wallet” (e.g., an owner of the respective bank accounts, credit cards, loyalty cards etc.). It shall be understood that although referred by different terms, “a current user” may be the same person as “an authorized user”, and may simply change the authorization status by successfully passing the authorization procedure.

In certain embodiments, upon receiving reference authentication data element 11A, communication module 22 may be further configured to activate biometric data capturing module 23 (e.g., via procedures 221B and 222B, shown in FIG. 4B). Biometric data capturing module 23 may be configured to receive authentication data (e.g., biometric data) entered by the user, and to form input authentication data element 23A therefrom, said input authentication data element 23A uniquely identifying the current user (e.g., via procedure 231B, shown in FIG. 4B). E.g., input authentication data element 23A may be a fingerprint, a face image, a 3D map of the face, etc.

In certain embodiments, authentication data elements 11A and 23A may represent biometric data of the respective user, said biometric data encoded by applying predetermined one-way-encryption algorithm (which may be applied on mobile device 10 and payment terminal 20 before transferring the respective authentication data element), e.g., using ML-based encoder, pretrained to calculate compressed knowledge representation of the biometric data and then applying a hash-function thereto. Thereby, System 100 enhances security for essential data by ensuring that original biometric data cannot be reconstructed from the authentication data elements 11A and 23A. Therefore, this safeguard remains effective even in the event of unauthorized and malicious network activity.

In certain embodiments, biometric data capturing module 23 may be further configured to transfer input authentication data element 23A to communication module 22, and communication module 22 may be further configured to send reference authentication data element 11A and input authentication data element 23A to communication module 36 (e.g., via procedures 223B and 224B, shown in FIG. 4B). The abovementioned data transmission from payment terminal 20 to payment server 30 may be integrated into other steps described above, e.g., reference authentication data element 11A and input authentication data element 23A may be transmitted within a single data package with other data, e.g., with payment token 10A, store or product identifier 22A, and an amount 22B to be paid (e.g., via data transferring 221A shown in FIG. 4A). It shall be understood that the steps of the authorization procedure are shown separately for the purpose of clarity only.

Accordingly, communication module 36 may be configured to receive reference authentication data element 11A and input authentication data element 23A (e.g., via procedures 224B and 364B, shown in FIG. 4B).

In certain embodiments, payment server 30 may further include transaction authorization module 37. Communication module 36 may be further configured to retransfer reference authentication data element 11A and input authentication data element 23A to transaction authorization module 37 (e.g., via procedure 365B, shown in FIG. 4B). In certain embodiments, transaction authorization module 37 may be configured to determine similarity metric value 37A representing a degree of similarity between reference authentication data element 11A and input authentication data element 23A.

In certain embodiments, said determination of the similarity may be performed using known ML-based techniques, e.g., using deep learning models, respectively pretrained on the plurality of authentication data elements to extract the most critical features thereof and to evaluate similarity by comparing values of these features between authentication data elements.

In certain embodiments, transaction authorization module 37 may be further configured to authorize the payment transaction, based on similarity metric value 37A and output a binary transaction authorization result data element (not shown), indicating whether the transaction is authorized (e.g., via procedures 371B and 372B, shown in FIG. 4B). In certain embodiments, transaction authorization module 37 may be further configured to authorize the payment transaction, if similarity metric value 37A surpasses a predefined similarity metric threshold value (can be set at the new user registration stage). It shall be understood that in case similarity metric value 37A surpasses the predefined similarity metric threshold value it indicates that reference authentication data element 11A and input authentication data element 23A are sufficiently similar to each other, thereby proving that the current user is the authorized user.

In certain embodiments, payment server 30 may be further configured to retrieve, from digital wallet DB 38, said information 38′ (e.g., procedure 381A, shown in FIG. 4B, as described above), provided that the transaction is authorized, that is, upon obtaining the binary transaction authorization result data element (not shown), indicating that the transaction is authorized. It shall be appreciated that, although shown separately, transaction authorization steps may be combined with or integrated into other steps, described herein (e.g., procedures 371B and 372B, shown in FIG. 4B may precede procedures 361A and 381A, shown in FIG. 4A).

In certain embodiments, communication module 36 (or payment amount analyses module 31) may be further configured to retrieve, from digital wallet information DB 38, fund transfer mandate data element 31A′, based on at least one of: (i) payment token 10A; and (ii) reference authentication data element 11A. For example, depending on specific embodiments, fund transfer mandate data element 31A′ may be stored in association with payment token 10A, and, e.g., may be encrypted using an encryption key, which can be generated based on reference authentication data element 11A. For example, before transferring fund transfer mandate data element 31A′ from mobile device 10 to payment server 30 (e.g., via abovementioned procedures 112B and 113B, shown in FIG. 4B), mobile device 10 may be configured to encrypt fund transfer mandate data element 31A′ using said encryption key, and send it in the encryption version. Upon receiving reference authentication data element 11A and authorizing the transaction, payment server 30 may be further configured to: (i) generate the encryption key using reference authentication data element 11A; and (ii) decrypt retrieved fund transfer mandate data element 31A′ (e.g., within procedures 381B and 382B shown in FIG. 4B) using the generated encryption key.

In certain embodiments, communication module 36 (or payment amount analyses module 31) may be further configured to amend fund transfer mandate data element 31A′ to provide permission to merchant bank server 40 associated with store or product identifier 22A to request, from one or more user bank servers 50 associated with the respective retrieved one or more bank account identifiers (e.g., bank account identifiers taken from cost-effective payment method 33A that was confirmed by the user, as indicated in the respective user response data element 21A), a fund transfer to the merchant bank account according to the recalculated amount 31A″ to be paid.

In certain embodiments, communication module 36 may be further configured to transfer, to communication module 41 of merchant bank server 40, the amended fund transfer mandate data element 31A′ (e.g., procedures 366B and 367B shown in FIG. 4B), provided that the payment transaction is authorized.

In certain embodiments, communication module 41 of merchant bank server 40 may be accordingly configured to receive fund transfer mandate data element 31A′, and initiate, the fund transfer to the merchant bank account according to fund transfer mandate data element 31A′. E.g., merchant bank server 40 may obtain, from fund transfer mandate data element 31A′, one or more bank account identifiers (e.g., credit card numbers, bank account number etc.), amount 31A″ that needs to be requested from respective user's one or more banks (user bank servers 50) (e.g., procedure 411B shown in FIG. 4B). Merchant bank server 40 may further initiate the payment transaction by sending a request, to respective user bank servers 50, to receive from the respective user's bank account a respective amount 31A″ of funds (e.g., procedure 412B, shown in FIG. 4B).

It will be appreciated by the person skilled in the art that the transaction initiation procedure described above corresponds to a “pull” payment scheme, where the payee (the merchant) takes money from the debtor (the person making the payment). It shall be further understood that the present invention is not limited to “pull” payment scheme and, in certain embodiments, other schemes may be implemented.

E.g., in certain embodiments, that the transaction initiation procedure may correspond to a “push” payment scheme, where the payer (the customer) actively transfers funds from one source to another (e.g., to merchant's bank account).

E.g., in certain alternative embodiments (not shown in Figures), payment server 30 may be further configured to retrieve, from digital wallet information DB 38, fund transfer mandate data element 31A′, which may alternatively provide permission to transfer, to a merchant bank account associated with store or product identifier 22A, funds according to the recalculated amount to be paid 31A″ (based on at least one of: (i) the payment token; and (ii) the reference authentication data element, same as described in the “pull” embodiment above). Accordingly, payment server 30 may be further configured to amend fund transfer mandate data element 31A′ to provide permission to the one or more user bank servers associated with the respective retrieved one or more bank account identifiers (e.g., user bank servers 50) to transfer, to the merchant bank account associated with the store or product identifier, funds according to the recalculated amount to be paid. Payment server 30 may be further configured to transfer, to the one or more user bank servers (e.g., user bank servers 50), fund transfer mandate data element 31A′, provided that the payment transaction is authorized. User bank servers 50 (associated with a respective retrieved one or more bank account identifiers) may be accordingly configured to receive, from payment server 30, fund transfer mandate data element 31A′, and initiate the fund transfer to the merchant bank account (e.g., by communicating with merchant bank server 40), according to fund transfer mandate data element 31A′.

Referring now to FIGS. 3C, 3D and 4C, the aspects of applying system 100 for online purchases are explained in greater detail, according to certain embodiments. Specifically, FIG. 3C illustrates a block diagram, depicting aspects of mobile device 10 and merchant server 60 of system 100 (for online purchases applications); FIG. 3D illustrates a block diagram, depicting aspects of payment server 30 of system 100 (for online purchases applications); and FIG. 4C illustrates a sequence diagram, depicting aspects of a cost-effective payment method determination, as performed by system 100 when performing online purchases, according to certain embodiments.

It should be understood that, although presented separately, embodiments demonstrating the application of system 100 for online purchases are not exclusively alternative to those demonstrating its application for POS purchases (e.g., embodiments shown in FIGS. 3A-3B and 4A). Accordingly, in certain embodiments, system 100 may be configured to support both POS and online purchases. Furthermore, in such embodiments, the invention enhances the relevant technological field by enabling seamless integration into existing infrastructure, efficiently combining essential concepts for both POS and online transactions, as evident from the present discussion and accompanying figures.

As can be seen in FIGS. 3C, 3D and 4C, in certain embodiments, system 100 may include merchant server 60. In certain embodiments, merchant server 60 may function as a network node that hosts and manages the merchant's website or web service, facilitating online purchases via the Internet. This server provides essential e-commerce functionality, enabling users to access the merchant's platform through a web browser or a designated software application on their mobile device (e.g., mobile device 10). Utilizing commonly known technologies, such as web hosting, database management, and secure transaction processing, merchant server 60 may support product selection, order placement, and payment transaction initiation, ensuring seamless interaction between users and the merchant's digital storefront.

In certain embodiments, merchant server 60 may control (host) online purchase service 61 (online store), as known in the art. Merchant server 60 may further include communication module 62, enabling network access thereto. As provided by online purchase service 61, products and/or services for sale (i.e., virtual objects representing products), may be stored, in the memory of server 60, in association with store or product identifiers (e.g., identifier 62A), and amounts to be paid (e.g., amount 62B).

It shall be understood that, in the context of the present disclosure, although identified by different reference numbers, store or product identifier 62A and amount 62B to be paid may be the same as or equivalent to store or product identifier 22A and amount 22B to be paid (discussed with reference to FIGS. 3A-3B and 4A-4B), respectively.

In certain embodiments, mobile device 10 may further include a UI module 13. UI module 13 may comprise, for example, a display (e.g., a touchscreen) and program instructions that, when executed by the processor of mobile device 10, may output visual information via the display and receive sensor input, as commonly known in the art.

Accordingly, in certain embodiments, communication module 11 of mobile device 10 may be configured to establish remote network connection with communication module 62 the merchant server 60, e.g., via Internet (e.g., procedure 111C shown in FIG. 4C). Through the established connection, the user of mobile device 10 may interact with the interface of online purchase service 61, selecting the desired product.

In certain embodiments, merchant server 60 may be configured to receive, via online purchase service 61, online payment action 61A indicating request 61A from the current user to initiate the payment transaction (e.g., procedure 611C shown in FIG. 4C). In certain embodiments, action 61A may be the action of pressing a specific button (e.g., button “Buy”) in the interface of service 61, or other equivalent actions, which may be performed via UI module 13. Upon receiving action 61A, merchant server 60 may be configured to retrieve, from a database of products, identifier 62A and amount 62B, corresponding to the selected product. In certain embodiments, mobile device 10 may be further configured to provide, to merchant server 60, payment token 10A. E.g., the user may enter payment token 10A (i.e., a numerical or alphanumerical value) in a respective field of the user interface of online purchase server 61, which may be done, e.g., before or after online payment action 61A.

In certain embodiments, communication module 62 of merchant server 60 may be configured to establish network communication (e.g., via Internet) with communication module 36 of payment server 30. Merchant server 60 may be further configured to transmit, upon receiving the request from the current user, (i) payment token 10A, (ii) store or product identifier 62A, and (iii) amount 62B to be paid, to payment server 30 (e.g., procedure 621C shown in FIG. 4C), via the established network communication.

In some alternative embodiments (not shown in figures), merchant server 60 may be configured to transfer only identifier 62A and amount 62B to payment server 30, while payment token 10A may be transmitted directly from mobile device 10 to payment server 30, further enhancing security. For example, upon receiving action 61A, merchant server 60 may send a request to mobile device 10 to provide payment token 10A to payment server 30, and mobile device 10 may transmit payment token 10A in response.

To associate payment token 10A with the specific purchase (i.e., identifier 62A and amount 62B received from merchant server 60), payment server 30 may use a transaction identifier (not shown), which may be generated by merchant server 60 upon receiving action 61A, and transmitted to both payment server 30 and mobile device 10. Accordingly, payment server 30 may store identifier 62A and amount 62B in association with this transaction identifier. Mobile device 10, in turn, may transmit payment token 10A along with the transaction identifier to payment server 30.

Payment server 30 may then process identifier 62A, amount 62B, and payment token 10A, provided they are associated with the same transaction identifier.

The processing performed by payment server 30 for the purposes of online purchasing, may be similar as or equivalent to the processing performed for POS transactions. In particular, procedures 361C, 381C, 382C, 383C, 384C, 351C, 311C, 312C, 331C, 332C, 341C, 342C, 352C, and 363C shown in FIG. 4C, may be same as or equivalent to procedures 361A, 381A, 382A, 383A, 384A, 351A, 311A, 312A, 331A, 332A, 341A, 342A, 352A, 363A shown in FIG. 4A. For clarity and conciseness, discussions of similar and/or equivalent procedures are not repeated.

In certain embodiments, communication module 36 may be configured to transfer suggestion data elements 35A, 35B and 35C to mobile device 10, e.g., via communication module 11 (e.g., procedure 364C, as shown in FIG. 4C).

Communication module 11 may be further configured to transfer suggestion data elements 35A and 35B to UI module 13 (e.g., procedures 112C, and 113C, as shown in FIG. 4C).

In certain embodiments, mobile device 10 may be further configured to provide, via UI of UI module 13, suggestion data elements 35A, 35B and 35C (e.g., procedure 131C, as shown in FIG. 4C). In certain embodiments suggestion data elements 35A, 35B and 35C may be provided in the form of messages on the display of UI module 13, containing text, images, video, and virtual buttons for receiving user input (confirmation or declination) etc. Accordingly, in certain embodiments, mobile device 10 may be further configured to receive, via UI of UI module 13, current user response data element 13A representing one of (a) a confirmation of selecting the one of cost-effective payment methods 33A; and (b) a declination of selecting the one of cost-effective payment methods 33A (e.g., procedure 131C, as shown in FIG. 4C). In certain embodiments, mobile device 10 may be optionally further configured to receive, via UI of UI module 13, current user response data element 13B representing one of (a) a confirmation of the suggestion of new loyalty card data elements, new credit card data elements, and new bank accounts; and (b) a declination of the suggestion of new loyalty card data elements, new credit card data elements, and new bank accounts.

In accordance with the described above, in certain embodiments, UI module 13 may be further configured to provide suggestion data element 35B further based on probability 34A, e.g., by providing a list of cost-effective payment methods 33A sorted by probability 34A to represent cost-effective payment methods 33A that are most likely to be confirmed on top of the list; or by providing only those cost-effective payment methods 33A that have probability 34A higher than a certain predefined threshold; or simply providing cost-effective payment method 33A that has the highest probability 34A.

In certain embodiments, communication module 11 may be further configured to receive, from UI module 13, current user response data elements 13A and 13B (e.g., procedure 133C, as shown in FIG. 4C) and transfer current user response data elements 13A and 13B to communication module 36 (e.g., procedures 114C and 115C shown in FIG. 4C).

Mobile device 10 may be further configured to provide, via user interface of UI module 13, suggestion data element 35C. In certain embodiments, suggestion data element 35C serves as additional contextual information for the user, intending to inform the user about relevant products without expecting a response in return.

Same as in POS payment application, in the online payment application, confirmation of transaction procedure initiation may include the procedure of user authentication, which may be performed, e.g., before or upon procedure 131C, described above.

In the embodiments, directed to online purchases, the user authentication may be performed by mobile device 10 itself, as commonly known in the art. E.g., mobile device 10 may be further configured to receive, as an input, an input authentication data element (same as input authentication data element 11A, described with reference to FIG. 4B), e.g., by scanning user's fingerprint or face. Mobile device 10 may be further configured to determine degree of similarity between reference authentication data element 11A and the received input authentication data element. Mobile device 10 may be further configured to authorize the payment transaction, based on the determined similarity metric value, output a binary transaction authorization result data element (not shown), indicating whether the transaction is authorized, and to communicate it to payment server 30 (e.g., via procedures 114C and 115C, shown in FIG. 4C).

Alternatively, in certain embodiments, mobile device 10 may transfer reference authentication data element 11A and the received input authentication data element to payment server 30, which may perform user authentication procedure using transaction authorization module 37, same as discussed with reference to FIG. 4B.

The payment server 30 may also be configured to initiate the payment transaction, as described with reference to FIG. 4B.

As can be seen from the provided disclosure, the present invention represents a system and method of initiating payment transactions, which provide an improvement of the technological field of systems and methods specially adapted for commercial purposes (in particular, the field of payment architectures, schemes and protocols), by: (a) reducing computational loads on the mobile devices and POS-terminals and decreasing a number of actions performed at the consumer's end to initiate the electronic payment transaction, thereby accelerating a completion thereof; (b) decreasing a complexity of integration with existing technological solutions; and (c) maintaining the required security level.

While the disclosure has been presented and described in relation to different embodiments, it should be appreciated by those skilled in the art that modifications in form and details can be introduced without deviating from the essence and scope of the disclosure as defined by the appended claims and their equivalents.

It should also be understood that each of the presented embodiments does not impose any constraints as for the content of essential features. Accordingly, each of the present embodiments may be combined with others to incorporate their essential features, without deviating from the essence and scope of the present invention.

1. A method of initiating payment transactions, by at least one processor, the method comprising:
establishing wireless connection between a payment terminal and a mobile device, said payment terminal being connected to a payment server;
receiving, by the payment terminal from the mobile device via the established wireless connection, a payment token;
receiving, by the payment server from the payment terminal: (i) the payment token, (ii) a store or product identifier, and (iii) an amount to be paid;
retrieving, from a database stored on the payment server, a digital wallet information comprising: one or more bank account data elements, and a loyalty card data element; said digital wallet information being associated with the received payment token, and said loyalty card data element being further associated with the received store or product identifier;
recalculating, by the payment server, the amount to be paid, based on the retrieved loyalty card data element; and
initiating, by the payment server, the payment transaction, using: (i) the recalculated amount to be paid; and (ii) the retrieved one or more bank account data elements.

2. The method of claim 1, wherein the payment token is a numerical or alphanumerical identification code.

3. The method of claim 1, wherein the one or more bank account data elements comprise a bank account identifier, said bank account identifier selected from a list consisting of: (i) a credit card number associated with an authorized user of the mobile device; (ii) a billing address associated with the authorized user of the mobile device; and (iii) a bank account number associated with the authorized user of the mobile device.

4. The method of claim 3, wherein the digital wallet information further comprises a plurality of loyalty card data elements, containing the loyalty card data element associated with the received store or product identifier, said plurality of loyalty card data elements being associated with the payment token;
wherein the method further comprises selecting the loyalty card data element associated with the received store or product identifier from the plurality of loyalty card data elements, based on the received store and product identifier.

5. The method of claim 4, further comprising:
providing, via a user interface (UI) of the payment terminal, a first suggestion data element representing a suggestion of obtaining at least one of: new loyalty card data elements; new credit card data elements; and new bank accounts; based on at least one of: the retrieved digital wallet information; the amount to be paid; and the store or product identifier.

6. The method of claim 5, further comprising:
inferring, by the payment server, a respectively pretrained first machine-learning (ML)-based model on: the retrieved digital wallet information; the amount to be paid; and the store or product identifier, to calculate one or more cost-effective payment methods, each comprising at least one of: (i) a combined application of a specific bank account identifier of the one or more bank account identifiers and a specific loyalty card data element of the plurality of loyalty card data elements; (ii) a combined application of a specific bank account identifier of the one or more bank account identifiers and a specific new loyalty card data element; (iii) a combined application of a specific new bank account or a specific new credit card data element and a specific loyalty card data element of the plurality of loyalty card data elements; (iv) a combined application of a specific new bank account or a specific new credit card data element and a specific new loyalty card data element; (v) credit, and/or loan, and/or split payments options; and (vi) payment options involving cryptocurrencies and/or central bank digital currencies (CBDC); and
wherein initiating the payment transaction is further performed based on the calculated one or more cost-effective payment methods.

7. The method of claim 6, further comprising:
for each of the one or more cost-effective payment methods, calculating confidence metric value, representing a probability of a respective cost-effective payment method of the one or more cost-effective payment methods to have the highest cost effectiveness;
initiating the payment transaction further based on a first cost-effective payment method of the one or more cost-effective payment methods, said first cost-effective payment method having a highest calculated confidence metric value.

8. The method of claim 7, further comprising:
providing, via a user interface (UI) of the payment terminal, a second suggestion data element representing a suggestion of selecting one of the one or more cost-effective payment methods;
receiving, via the UI of the payment terminal, a current user response data element representing one of (a) a confirmation of selecting the one of the one or more cost-effective payment methods; and (b) a declination of selecting the one of the one or more cost-effective payment methods;
receiving, by the payment server from the payment terminal, the current user response data element; and
wherein initiating the payment transaction is further based on the current user response data element.

9. The method of claim 8, further comprising:
inferring, by the payment server, a respectively pretrained second ML-based model on the calculated one or more cost-effective payment methods, to calculate, for each of the one or more cost-effective payment methods, a probability of receiving a user response data element respectively representing one of (a) a confirmation of selecting a respective cost-effective payment method of the one or more cost-effective payment methods; and (b) a declination of selecting the respective cost-effective payment method of the one or more cost-effective payment methods; and
providing, via the UI of the payment terminal, the second suggestion data element further based on the calculated probability.

10. The method of claim 9, further comprising:
receiving, by the payment server, a plurality of retrospective user response data elements, each representing one of (a) a confirmation of selecting the respective cost-effective payment method of the one or more cost-effective payment methods; and (b) a declination of selecting the respective cost-effective payment method of the one or more cost-effective payment methods, said retrospective user response data elements being obtained during previous payment transactions; and
training, by the payment server, the second ML-based model to calculate a probability of receiving upcoming user response data elements, each representing one of (a) a confirmation of selecting the respective cost-effective payment method of the one or more cost-effective payment methods; and (b) a declination of selecting the respective cost-effective payment method of the one or more cost-effective payment methods, by using the plurality of retrospective user response data elements as a supervisory dataset.

11. The method of claim 10, further comprising:
supplementing, by the payment server, the supervisory dataset with the current user response data element; and
retraining, by the payment server, the second ML-based model using the supplemented supervisory dataset.

12. The method of claim 6, wherein the one or more bank account data elements further comprise at least one fee value associated with said bank account identifier; and
wherein the method further comprises:
for each of the one or more bank account data elements:
(i) calculating a frequency of performing payment transactions using a respective bank account identifier; and
(ii) recalculating a respective at least one fee value, based on the calculated frequency; and
wherein inferring, by the payment server, the respectively pretrained first ML-based model is further performed on the recalculated at least one fee value, to calculate the one or more cost-effective payment methods.

13. The method of claim 4, further comprising: providing, via a user interface (UI) of the payment terminal, a third suggestion data element representing a suggestion of purchasing a new product, based on at least one of: the store or product identifier; and a plurality of store or product identifiers associated with previous transactions.

14. The method of claim 3, further comprising:
receiving, by the payment terminal from the mobile device via the established wireless connection, a reference authentication data element, uniquely identifying the authorized user of the mobile device;
receiving, via an input module of the payment terminal, an input authentication data element, entered by a current user, said input authentication data element uniquely identifying the current user;
receiving, by the payment server from the payment terminal: (i) the reference authentication data element; and (ii) the input authentication data element;
determining, by the payment server, a similarity metric value, representing a degree of similarity between the reference authentication data element and the input authentication data element; and
wherein initiating the payment transaction further comprises authorizing the payment transaction, based on the similarity metric value.

15. The method of claim 14, wherein the input module comprises a biometric data capturing module, and wherein the reference authentication data element and the input authentication data element represent biometric data of the authorized user and the current user, respectively.

16. The method of claim 14, wherein authorizing a payment transaction, based on the similarity metric value, comprises confirming that the current user is the authorized user, provided that the similarity metric value surpasses a predefined similarity metric threshold value.

17. The method of claim 14, wherein the method further comprises:
receiving, by a merchant bank server associated with the store or product identifier, from the payment server, a fund transfer mandate data element, providing permission to request, from one or more user bank servers associated with a respective retrieved one or more bank account identifiers, a fund transfer to a merchant bank account according to the recalculated amount to be paid; and
initiating, by the merchant bank server, the fund transfer to the merchant bank account according to the fund transfer mandate data element.

18. The method of claim 17, further comprising:
retrieving, from the database stored on the payment server, the fund transfer mandate data element, based on at least one of: (i) the payment token; and (ii) the reference authentication data element;
amending the fund transfer mandate data element to provide permission to the merchant bank server associated with the store or product identifier to request, from one or more user bank servers associated with the respective retrieved one or more bank account identifiers, a fund transfer to the merchant bank account according to the recalculated amount to be paid; and
transferring, from the payment server to the merchant bank server, the fund transfer mandate data element, provided that the payment transaction is authorized.

19. The method of claim 14, wherein the method further comprises:
receiving, by one or more user bank servers associated with a respective retrieved one or more bank account identifiers, from the payment server, a fund transfer mandate data element, providing permission to transfer, to a merchant bank account associated with the store or product identifier, funds according to the recalculated amount to be paid;
initiating, by the one or more user bank servers, the fund transfer to the merchant bank account according to the fund transfer mandate data element.

20. A system for initiating payment transactions, the system comprising:
a mobile device;
a payment terminal;
and a payment server in operative connection with the payment terminal;
wherein each of the mobile device, the payment terminal and the payment server comprises a non-transitory memory module, wherein modules of program instructions are stored, and at least one processor associated with the memory module, and configured to execute the modules of program instructions, whereupon execution of said modules of program instructions,
the processors of the mobile device and the payment terminal are configured to establish wireless connection between the payment terminal and the mobile device;
the processor of the mobile device is configured to transfer, to the payment terminal, via the established wireless connection, a payment token;
the processor of the payment terminal is configured to:
receive, from the mobile device, via the established wireless connection, the payment token; and
transfer, to the payment server: (i) the payment token, (ii) a store or product identifier, and (iii) an amount to be paid; and
the processor of the payment server is configured to:
receive, from the payment terminal: (i) the payment token, (ii) a store or product identifier, and (iii) an amount to be paid;
retrieve, from a database stored on the payment server, a digital wallet information comprising: one or more bank account data elements, and a loyalty card data element; said digital wallet information being associated with the received payment token, and said loyalty card data element being further associated with the received store or product identifier;
recalculate the amount to be paid based on the retrieved loyalty card data element; and
initiate the payment transaction, using: (i) the recalculated amount to be paid; and (ii) the retrieved one or more bank account data elements.
